(19) United States
(12) Patent Application Publication
(10) Pub. No.: US 2026/0135978 A1
(43) Pub. Date: May 14, 2026

(54) PULSE WIDTH MODULATION SEQUENCING IN LIGHT PROJECTION SYSTEMS USING LIGHT-RECYCLING COLOR FILTERS

(71) Applicant: TEXAS INSTRUMENTS INCORPORATED, Dallas, TX (US)

(72) Inventors: Aravind Lakshminarayanan, Frisco, TX (US); Jeffrey Matthew Kempf, Dallas, TX (US)

(21) Appl. No.: 19/302,922

(22) Filed: Aug. 18, 2025

Related U.S. Application Data
(60) Provisional application No. 63/693,246, filed on Sep. 11, 2024.

(51) Int. Cl. H04N 9/31; G02B 26/00; G03B 21/00; G03B 21/20

(52) U.S. Cl. CPC H04N 9/3123; G02B 26/008; G03B 21/005; G03B 21/204; H04N 9/3111; H04N 9/3161

(57) ABSTRACT

Pulse width modulation (PWM) sequencing in light projection systems configured with light-recycling color filters. In an example, a method includes: extracting, using control circuitry, from an image frame, image data associated with a color component of the image frame; producing, with one or more processors of the control circuitry, a bit plane sequence responsive to the image data; and outputting, by the control circuitry, a plurality of copies of the bit plane sequence, respective copies of the bit plane sequence being output at respective time intervals with a time delay between successive time intervals. In this manner, a staggered (e.g., delayed with respect to one another over time) set of bit plane sequences is produced which can be converted to signal format (e.g., PWM signals) and provided to a spatial light modulator in synchrony with movement of color transitions across the spatial light modulator.

### CROSS-REFERENCE TO RELATED APPLICATIONS

This application claims the benefit of and priority to U.S. Provisional Application No. 63/693,246 filed on Sep. 11, 2024, which is herein incorporated by reference in its entirety.

### TECHNICAL FIELD

This description relates to projection display systems, and more particularly, to pulse width modulation (PWM) techniques for use in display systems employing spatial light modulators.

### BACKGROUND

Projection display systems project images onto surfaces, such as onto a screen of the display system or an external surface, to display video or still pictures. Some projection display systems use a spatial light modulator that includes adjustable display elements, generally arranged in a matrix of rows and columns. The display elements form images with image location blocks, also referred to herein as pixels, on the screen or the surface where the image is projected. The display elements are adjusted by a controller to provide, based on color shades in the pixels of a displayed image, levels of brightness in the displayed image. The image data is also processed according to an image modulation scheme, such as pulse width modulation (PWM), to control the intensity and rate of the displayed images for proper viewing by a human eye.

### SUMMARY

In one example, a method comprises: with control circuitry, extracting from an image frame, image data associated with a color component of the image frame; producing, with one or more processors of the control circuitry, a bit plane sequence responsive to the image data; and outputting, by the control circuitry, a plurality of copies of the bit plane sequence, respective copies of the bit plane sequence being output at respective time intervals with a time delay between successive time intervals.

According to another example, a system comprises a spatial light modulator, an illumination system optically coupled to the spatial light modulator, the illumination system comprising a rotatable color wheel, and a display controller coupled to the spatial light modulator. The display controller may include a frame memory configured to store an image frame, a frame memory controller coupled to the frame memory, the frame memory controller configurable to obtain image data from the image frame, the image data associated with a color component of the image frame, and a bit plane generator coupled to the frame memory controller, the bit plane generator configurable to produce a bit plane sequence responsive to the image data. In one example, the display controller is configurable to output first and second copies of the bit plane sequence to the spatial light modulator at first and second time intervals, respectively, a time delay between the first and second time intervals being synchronized with a rate of rotation of the color wheel.

According to another example, a system comprises a light source configured to emit first light having a first color, a rotatable phosphor wheel optically coupled to the light source, the phosphor wheel comprising a first segment configured to transmit the first light and a second segment configured to emit, responsive to the first light, second light having a second color, and a rotatable color filter wheel optically coupled to the phosphor wheel. The color filter wheel may comprise a third segment configured to transmit the first light and a first component of the second light and to reflect a second component of the second light, and a fourth segment configured to transmit the first light and the second component of the second light and to reflect the first component of the second light, wherein the first component of the second light has a third color and the second component of the second light has a fourth color. The system may further comprise a controller configurable to synchronize rotation of the phosphor wheel and the color filter wheel to cause the color filter wheel to transmit filtered light in a pattern of color time slots, wherein the pattern of color time slots comprises a first time slot of the first color, followed by a first series of alternating time slots of the third color and the fourth color, followed by a second time slot of the first color, followed by a second series of alternative time slots of the fourth color and the third color.

In another example, a system comprises a spatial light modulator, and an illumination system optically coupled to the spatial light modulator. The illumination system may comprise a rotatable color wheel comprising a plurality of segments configured to transmit light of different colors. In one example, the system further comprises a display controller coupled to the spatial light modulator, the display controller including a frame memory configured to store an image frame, and control circuitry coupled to the frame memory and configurable to obtain image data representing a plurality of color components of the image frame. The control circuitry may be configurable to produce a multi-color bit plane sequence responsive to the image data and to a parametric description of an illumination pattern on the spatial light modulator of the light transmitted from the rotatable color wheel. The control circuitry may further be configurable to output the multi-color bit plane sequence to the spatial light modulator to control the spatial light modulator to display the image frame.

According to another example, a system comprises a spatial light modulator and a display controller coupled to the spatial light modulator and configurable to control the spatial light modulator according to a multi-color bit plane sequence. The display controller may include a frame memory configured to store an image frame, a frame memory controller configurable to obtain image data from the image frame, the image data representing a plurality of color components of the image frame, a bit plane generator coupled to the frame memory controller, the bit plane generator configurable to produce the multi-color bit plane sequence responsive to the image data, and a processor coupled to the bit plane generator, the processor configurable to control the bit plane generator to produce the multi-color bit plane sequence according to a parametric description of one or more color transitions of multi-color illumination on the spatial light modulator.

According to another example, a method comprises extracting, from an image frame, image data representing a plurality of color components of the image frame, accessing, with a processor, a stored parametric description of one or more color transitions of multi-color illumination on a spatial light modulator, producing, with a processor, a multi-color bit plane sequence responsive to the image data and the parametric description, and generating, from the multi-color bit plane sequence, a sequence of pulse width modulation (PWM) control signals to control the spatial light modulator to display the image frame responsive to the multi-color illumination.

### BRIEF DESCRIPTION OF THE DRAWINGS

FIG. 1 is a block diagram of a display system, according to an example.

FIG. 2A is a block diagram of a portion of the display system of FIG. 1, showing light-recycling illumination optics and a yellow light optical path, according to an example.

FIG. 2B is a block diagram of the portion of the display system of FIG. 2A, showing a blue light optical path, according to an example.

FIG. 3 is a diagram of a phosphor wheel, according to an example.

FIG. 4 is a two-dimensional array of display elements of a spatial light modulator, according to an example.

FIG. 5 is a diagram illustrating illumination light output from a color filter wheel, according to an example.

FIG. 6A is a diagram showing color segments of a color filter wheel and a phosphor wheel, according to an example.

FIG. 6B is a diagram showing illumination light produced from a combination of the color filter wheel and the phosphor wheel of FIG. 6A, according to an example.

FIG. 7A is a diagram showing a color spoke, according to an example.

FIG. 7B is a diagram showing a combination of illumination patterns, according to an example.

FIG. 8 is a diagram showing color spokes moving across a spatial light modulator, according to an example.

FIG. 9A is a block diagram of a controller that may be part of the display system of FIG. 1, according to an example.

FIG. 9B is a block diagram of control circuitry that may be part of the controller of FIG. 9A, according to an example.

FIG. 10 is a block diagram illustrating a process for generating bit planes, according to an example.

FIG. 11A is a diagram illustrating a set of staggered bit plane sequences, according to an example.

FIG. 11B is a diagram illustrating re-ordered bit planes in the bit plane sequences of FIG. 11A, according to an example.

FIG. 12 is a diagram showing a color spoke on a spatial light modulator, according to an example.

FIG. 13 is a diagram showing color spokes moving across a spatial light modulator, according to an example.

FIG. 14A is a block diagram showing multiple controllers used to control a spatial light modulator, according to an example.

FIG. 14B is a block diagram showing the multiple controllers used to control the spatial light modulator, according to another example.

FIG. 15 is a flow diagram of a method of controlling a spatial light modulator, according to an example.

FIG. 16 is a flow diagram of another method of controlling a spatial light modulator, according to an example.

### DETAILED DESCRIPTION

Techniques are described for producing pulse width modulation sequences for controlling a spatial light modulator in projection display systems that include a light-recycling color filter. In some examples, bit plane sequences are derived from image data representing particular color components of an image to be displayed by the projection display system and these bit plane sequences are converted into pulse width modulation sequences for controlling the spatial light modulator to project the image. For example, a method may include using control circuitry to extract, from an image frame, image data associated with a color component of the image frame, and producing, with one or more processors of the control circuitry, a bit plane sequence responsive to the image data. The method may further include outputting, by the control circuitry, a plurality of copies of the bit plane sequence, with respective copies of the bit plane sequence being output at respective time intervals with a time delay between successive time intervals. In this manner, a staggered (e.g., delayed with respect to one another over time) set of bit plane sequences can be produced and loaded to the spatial light modulator in synchrony with movement of color transitions across the spatial light modulator, as described below. In another example, a method includes using control circuitry to extract, from an image frame, image data representing a plurality of color components of the image frame, and accessing, with a processor of the control circuitry, a stored parametric description of one or more color transitions of multi-color illumination on a spatial light modulator. The method may further include producing, with the processor(s), a multi-color bit plane sequence responsive to the image data and the parametric description, and generating, from the multi-color bit plane sequence, a sequence of pulse width modulation (PWM) control signals to control the spatial light modulator to display the image frame responsive to the multi-color illumination. Further examples provide apparatus, devices and systems for implementing such methods and variations thereof, as described below.

### General Overview

In some projection display systems that employ a spatial light modulator, the display elements of the spatial light modulator are controlled between an “ON” state in which light is propagated towards a display so as to generate a bright image pixel on the display, and an “OFF” state in which light is propagated away from the display so as to result in a dark image pixel on the display. Control of the display elements of the spatial light modulator can be achieved through Pulse Width Modulation (PWM) sequencing in which the sequences describe time periods for which individual display elements are in the ON state and the OFF state. In some examples, the display system projects color images by sequentially illuminating the spatial light modulator with light of three or more primary colors (e.g., red, green, blue) within each frame period, so that the spatial light modulator sequentially projects images of these primary colors within that frame period. Assuming that the frame period is sufficiently short, the human eye will integrate the sequential primary color images into a single full-color-image. Some projection display systems use color wheels to produce multiple illumination colors from a light source that emits light of a single color. For example, some projectors include a blue laser light source and use a phosphor wheel to produce yellow light from the blue light. Some such systems may further include a color filter wheel to obtain red and green light from the yellow light, such that the system can produce an illumination beam for the spatial light modulator that includes all three primary colors. The use of a color filter to extract red and green light from yellow light can introduce some inefficiency into the system because a portion of the yellow light is unused. Light recycling, in which the unused portion of light is recycled through the optical train and used to illuminate the spatial light modulator, can be used to help reduce this inefficiency. In some examples, light recycling can be achieved by imaging a color filter wheel (e.g., one having concentric segments of different color filters) onto the spatial light modulator, as described below. In some instances, PWM sequencing in some projection display systems assumes global color transitions, that is, all (used) display elements in the array transition from being illuminated with light of one color to being illuminated with light of another color at the same time. However, in systems that support light recycling using a color filter wheel, the circular arrangement of the color filters on the wheel may result in some color transitions being non-global, that is, phased differently across the spatial light modulator. In some cases, the color transition seen across the spatial light modulator may have a curved profile. However, as the spatial light modulator generally has a rectangular array of display elements, loading data to the spatial light modulator in a curved fashion may present numerous challenges.

Examples described herein provide techniques for producing bit plane sequences that may account for non-global, potentially curved (or otherwise non-linear or non-rectangularly shaped) color transitions across a spatial light modulator. Certain examples provide techniques for reducing or minimizing color transition artifacts using a phased sequencing scheme in which data is loaded to reset groups (e.g., groups of display elements of the spatial light modulator) in a manner that tracks the color transitions across the array of display elements. For example, a system may comprise a spatial light modulator, an illumination system optically coupled to the spatial light modulator, the illumination system comprising a rotatable color wheel, and a display controller coupled to the spatial light modulator. The display controller may include a frame memory configured to store an image frame, a frame memory controller coupled to the frame memory, and a bit plane generator coupled to the frame memory controller, wherein the frame memory controller is configurable to obtain image data from the image frame, the image data associated with a color component of the image frame, and the bit plane generator is configurable to produce a bit plane sequence responsive to the image data. In one example, the display controller is configurable to output first and second copies of the bit plane sequence to the spatial light modulator at first and second time intervals, respectively, with a time delay between the first and second time intervals being synchronized with a rate of rotation of the color wheel.

Certain other examples, rather than using the reset groups to track color transitions, use multi-color bit plane sequences that can be loaded to the full array of display elements at the same time. In some examples in which a projection display system includes a phosphor wheel and a color filter wheel, an individual multi-color bit plane sequence represents a “snapshot” in time of the wheels corresponding to a particular position of phosphor wheel relative to the color filter wheel. The multi-color bit plane sequence may be produced using a geometrical description of the color transition for the corresponding position of the wheels. Sequential multi-color bit plane sequences can be loaded to the spatial light modulator at a particular rate that is sufficiently fast to minimize artifacts that could arise due to appreciable movement of the color wheels between loading of successive bit plane sequences.

In some examples, a system comprises a spatial light modulator, an illumination system optically coupled to the spatial light modulator, and a display controller coupled to the spatial light modulator. The illumination system may comprise a rotatable color wheel comprising a plurality of segments configured to transmit light of different colors. The display controller may include a frame memory configured to store an image frame, and control circuitry coupled to the frame memory and configurable to obtain image data representing a plurality of color components of the image frame. The control circuitry may be configurable to produce a multi-color bit plane sequence responsive to the image data and to a parametric description of an illumination pattern on the spatial light modulator of the light transmitted from the rotatable color wheel. The control circuitry further may be configurable to output the multi-color bit plane sequence to the spatial light modulator to control the spatial light modulator to display the image frame.

Further, in some examples in which a light-recycling projection display system includes a light source, a rotatable phosphor wheel, and a light-recycling rotatable color filter wheel, the system can be configured to correct for a “venetian blind” effect that may other occur due to color transitions that occur during the light-recycling portion of illumination. For example, a system may comprise a light source configured to emit first light having a first color, a rotatable phosphor wheel optically coupled to the light source, and a rotatable color filter wheel optically coupled to the phosphor wheel. The phosphor wheel may comprise a first segment configured to transmit the first light and a second segment configured to emit, responsive to the first light, second light having a second color. The color filter wheel may comprise a third segment configured to transmit the first light and a first component of the second light and to reflect a second component of the second light, and a fourth segment configured to transmit the first light and the second component of the second light and to reflect the first component of the second light, wherein the first component of the second light has a third color and the second component of the second light has a fourth color. The system may further comprise a controller configurable to synchronize rotation of the phosphor wheel and the color filter wheel to cause the color filter wheel to transmit filtered light in a pattern of color time slots, wherein the pattern of color time slots comprises a first time slot of the first color, followed by a first series of alternating time slots of the third color and the fourth color, followed by a second time slot of the first color, followed by a second series of alternative time slots of the fourth color and the third color.

These and other aspects are described in more detail below.

### Example System Architecture

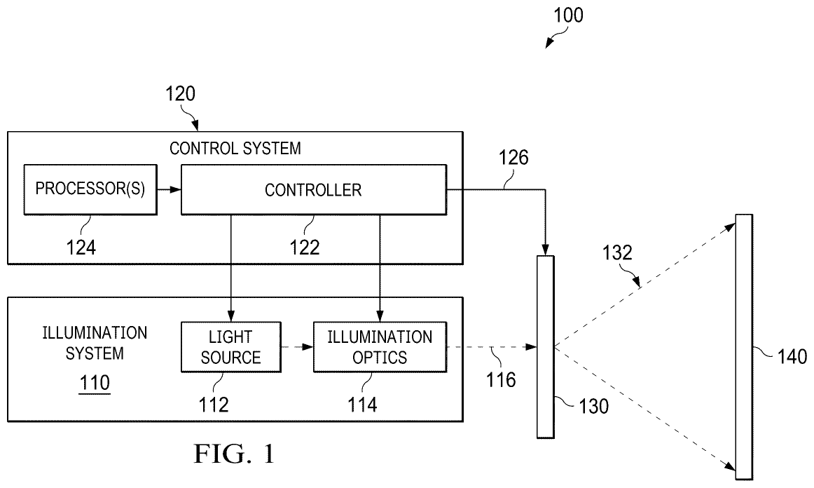

FIG. 1 is a block diagram of a display system 100 in accordance with various examples. The display system 100 includes an illumination system 110, a control system 120, and a spatial light modulator 130. The display system 100 may display images or video by projecting image frames at a certain frame rate onto a display 140 (e.g., a screen or a surface). In some examples, the illumination system 110 includes a light source 112 (e.g., one or more laser light sources, light emitting diodes, etc.) and illumination optics 114 that are optically coupled to the light source 112. The illumination system 110 produces illumination light 116 (also referred to as an illumination beam). Examples of the light source 112 and the illumination optics 114 are described below. The illumination system 110 can be configured to illuminate the spatial light modulator 130 with the illumination light 116. Thus, the spatial light modulator 130 can be optically coupled to the illumination system 110. The spatial light modulator 103, responsive to the illumination light 116 and under control of the control system 120, projects light 132 (also referred to as a projection beam, projected light, or projection light) onto the display 140. The display may be a display device, such as a screen of a computer, television, or other electronic device, or a display surface, such as a wall, roadway, canvas, or screen, to name a few examples. The projected light 132 is modulated by the spatial light modulator 130 to project still images or moving images (e.g., video) on the display 140.

The spatial light modulator 130 includes an array of display elements (not shown) for manipulating the incident illumination light 116 to form and project an image. The display elements form respective pixels of the image displayed on the display 140. In some examples, the spatial light modulator 130 may be a micro-electromechanical system (MEMS) device, such as a digital micromirror device (DMD) in which the display elements are micromirrors having adjustable movements for directing by reflection, modulating, and combining the illumination light 116 from the illumination system 110 into the projected light 132. In other examples, the spatial light modulator 130 may be liquid crystal display (LCD) device, or liquid crystal on silicon (LCoS) display device.

In some examples, the control system 120 includes a controller 122 and one or more processor(s) 124. The controller 122 is coupled to the spatial light modulator 130 and configurable to control the display elements of the spatial light modulator 130 according to image data representing the image to be displayed on the display 140. In some examples, control signals 126 produced by the controller 122 for controlling the display elements of the spatial light modulator 130 carry image data that represents modulated image frames according to PWM. The control signals 126 adjust the display elements of the spatial light modulator 130 to modulate the illumination light 116 and thereby shape the projected light 132 and form the image onto the display 140.

According to certain examples, the controller 122 further may control one or more components of the illumination system 120. For example, the controller 122 may control the light source 112 to emit the illumination light 116 and may control one or more elements of the illumination optics 114 to condition the illumination light 116. For example, the illumination optics 114 may include one or more rotatable color wheels, and the controller 122 may control a rate of rotation of the color wheel(s), for example. In the example shown in FIG. 1, the controller 122 is shown coupled to the light source 112, the illumination optics 114, and the spatial light modulator 130. However, in other examples, the control system 120 may include one or more additional controllers (not explicitly shown in FIG. 1) for controlling components of the illumination system 110 and/or the spatial light modulator 130. In some such examples, the processor(s) 124 may control synchronization among the controller 122 and any additional controllers. In some examples, the processor(s) 124 may process the image data that is used by the controller 122 to produce the control signals 126 for the spatial light modulator 130, for example. In some examples, the control system 120 further includes one or more memory components or other processor-readable storage devices (not explicitly shown in FIG. 1) for storing executable program instructions for the processor(s) 124.

As used herein, the term “processor” describes circuitry that executes a function, an operation, or a sequence of operations. The function, operation, or sequence of operations can be hard coded into the circuitry or soft coded by way of instructions held in a memory device and executed by the circuitry. In some examples, the processor(s) 124 include one or more digital processors; however, the processor(s) 124 can be analog, digital, or mixed. As such, the processor(s) 124 can execute the function, operation, or sequence of operations using digital values and/or using analog signals. In some examples, the processor(s) 124 can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), or multicore processors. Examples of the processor(s) 124 that are multicore can provide functionality for parallel, simultaneous execution of instructions or for parallel, simultaneous execution of one instruction on more than one piece of data.

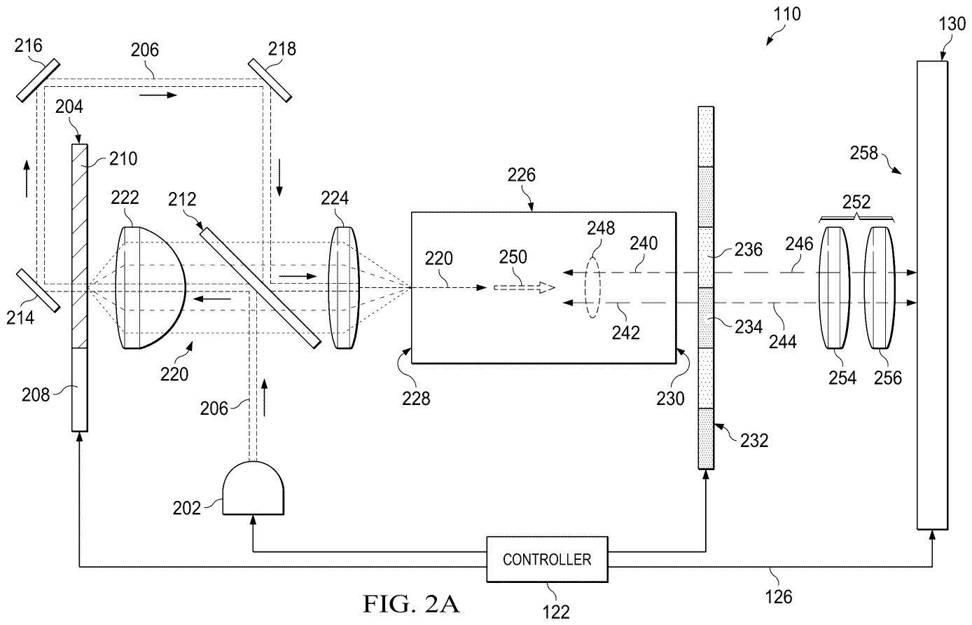

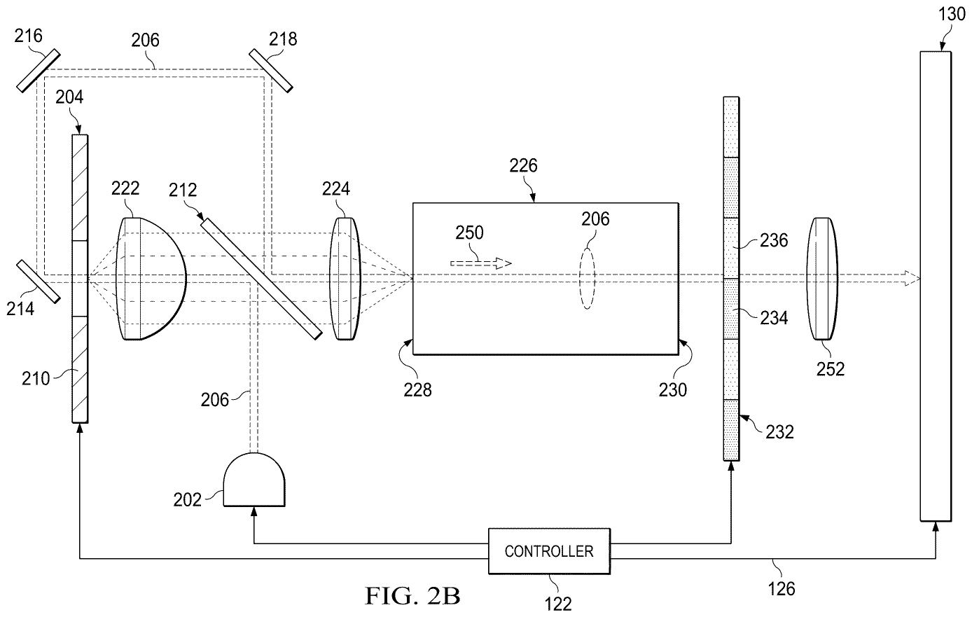

Referring to FIGS. 2A and 2B, there is illustrated a portion of the display system 100, showing a side view of the illumination system 110, according to an example. In this example, the light source 112 of FIG. 1 includes at least one laser diode 202 that emits laser light. In some examples, the laser diode 202 is a blue laser diode that emits blue light 206, e.g., blue laser light; however, in other examples, the laser light may be of a different color. Accordingly, for simplicity, examples described below refer to blue light 206 from the laser diode 202; however, it will be appreciated that the techniques and principles described herein are not limited to blue laser light and may be applied to other colors. In the example of FIGS. 2A and 2B, the illumination system 110 is illustrated as having a path of light from a phosphor member (in this example a rotatable phosphor wheel 204) through a light-propagating device (in this example an integrator rod 226) and onto a receiving face 258 of the spatial light modulator 130.

In one example, the blue light 206 emitted by the laser diode 202 is reflected from a dichroic mirror 212 and is focused by a first lens 222 towards the phosphor wheel 204. Accordingly, the phosphor wheel 204 may be optically coupled to the laser diode 202 via the dichroic mirror 212 and the first lens 222. The phosphor wheel 204 may include one or more phosphor regions 210 that comprise a phosphor. When illuminated by the blue light 206, the phosphor may be stimulated to produce an emission. In some examples, the phosphor produces yellow light 220 as the emission responsive to stimulation by the blue light 206. Accordingly, in such examples, the dichroic mirror 212 reflects blue light and transmits yellow light. In the example of FIGS. 2A and 2B, the phosphor region(s) 210 of the phosphor wheel 204 are reflective; however, in other examples, these regions may be transmissive.

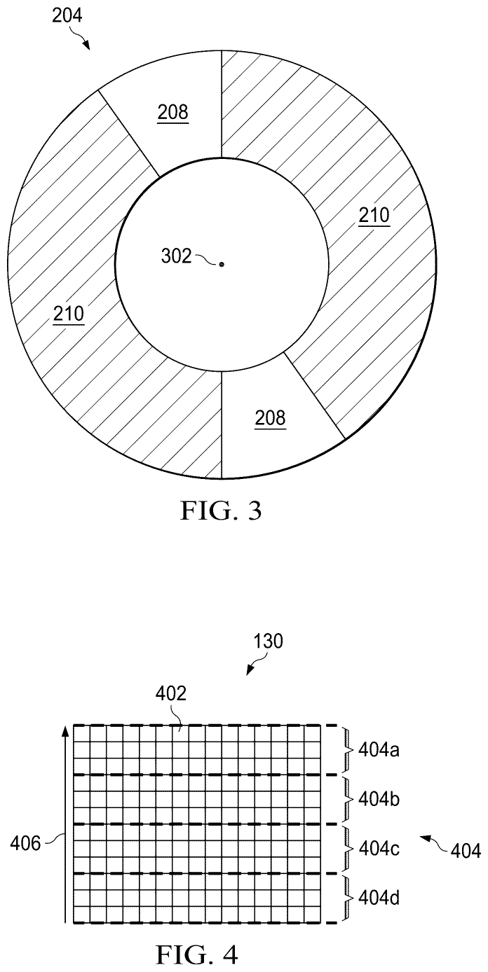

FIG. 3 shows a plan view of the phosphor wheel 204, according to an example. As described above, the phosphor wheel 204 includes one or more phosphor regions 210 comprising a phosphor that emits the yellow light 220 responsive to illumination by the blue light 206. The phosphor wheel 204 may further include one or more “pass through” or transmissive regions 208 that do not comprise the phosphor and instead allow the blue light 206 to pass through to a first mirror 214 (FIGS. 2A and 2B). The pass-through regions 208 may be composed of a transparent material. The phosphor wheel 204 is rotatable about a center axis 302 such that the phosphor regions 210 and the pass-through regions 208 are positioned in the path of the blue light 206. Accordingly, as the phosphor wheel 204 rotates, the blue light 206 may periodically encounter a phosphor region 210 (such that the yellow light 220 is produced) or a pass-through region 208 that allows the blue light 206 through to the first mirror 214. It should be noted that while the phosphor wheel 204 is illustrated as having two phosphor regions 210 and two pass-through regions 208, the phosphor wheel 204 may have an additional number of either regions, and need not have the same number of phosphor regions 210 as pass-through regions 208. Responsive to illumination by the blue light 206 from the laser diode 202, the phosphor wheel 204 produces alternating timeslots of the blue light 206 and the yellow light 220 as the phosphor wheel 204 rotates about its central axis 302.

Referring again to FIGS. 2A and 2B, when the phosphor wheel 204 is rotated such that a phosphor region 210 is in the path of blue light 206, the blue light 206 strikes the phosphor region 210 and is converted into the yellow light 220. With a reflective phosphor configuration, as illustrated in FIG. 2, the yellow light 220 is reflected from the phosphor region 210 back towards the first lens 222 proximate to the phosphor wheel 204. When the phosphor wheel 204 is rotated such that the blue light 206 encounters the pass-through region 208, the blue light 206 is transmitted to the first mirror 214. In the example configuration shown in FIGS. 2A and 2B, the illumination system 110 includes a “wrap-around” optical path for the blue light 206. The wrap-around path includes a second mirror 216 optically coupled to the first mirror 214, and a third mirror 218 optically coupled to the second mirror 216. The third mirror 218 is also optically coupled to the dichroic mirror 212. In the wrap-around path configuration, the blue light 206 may be reflected from the first mirror 214 to the second mirror 216, from the second mirror 216 to the third mirror 218, and from the third mirror 218 to the dichroic mirror 212, as shown. The dichroic mirror 212 is optically coupled to a second lens 224, and reflects the blue light 206 towards the second lens 224. The dichroic mirror 212 also transmits the yellow light 220 from the first lens through to the second lens 224. The first lens 222 collimates the yellow light 220 and allows the yellow light 220 to pass to the second lens 224 through the dichroic mirror 212. The second lens 224 focuses the collimated yellow light 220 to a light-receiving end 228 of the integrator rod 226. Thus, for the yellow light 220, the phosphor wheel 204 is optically coupled to the integrator rod 226 via the first and second lenses 222, 224 and the dichroic mirror 212. For the blue light 206, the laser diode 202 is optically coupled to the integrator rod 226 via the dichroic mirror 212, the phosphor wheel 204 (e.g., the pass-through region 208), the first and second lenses 222, 224, and the first, second, and third mirrors 214, 216, 218.

It will be appreciated that although the example configuration shown in FIGS. 2A and 2B includes the wrap-around path for the blue light 206, other configurations can be implemented. For example, the region(s) of the phosphor wheel 204 that do not comprise the phosphor may be reflective to the blue light 206, rather than transmissive, and may thus reflect the blue light 206 back towards the dichroic mirror 212. In such examples, the dichroic mirror 212 may include an aperture to allow the reflected blue light 206 to pass through, or may be otherwise configured to allow the reflected blue light 206 from the phosphor wheel 204 to travel along a similar optical path as the yellow light 220 from the phosphor wheel 204. In other examples, the phosphor wheel 204 may be fully transmissive, such that regions 208 without the phosphor allow the blue light 206 to pass through, and regions 210 with the phosphor convert the blue light 206 to the yellow light 220 that continues along a path of travel past the phosphor wheel 204, rather than being reflected as shown in FIGS. 2A and 2B. In some such examples, the laser diode 202 may be positioned on the other side (e.g., to the left of) the phosphor wheel 204 relative to the arrangement shown in FIGS. 2A and 2B. In some such examples, the laser diode 202 may be configured and arranged to direct the blue light 206 towards the phosphor wheel 204 without the dichroic mirror 212, and the wrap-around path mirrors 214, 216, 218 also may be omitted. Numerous variations may be apparent in light of this disclosure. The precise optical configuration of the laser diode 202, phosphor wheel 204 and any associated optical elements (such as the mirrors 212, 214, 216, and/or 218, and the lenses 222, 224) may not be important and may take any form that directs the blue light 206 and the yellow light 220 from the phosphor towards the integrator rod 226.

Continuing with the examples of FIGS. 2A and 2B, the integrator rod 226 receives the yellow light 220 (FIG. 2A) and the blue light 206 (FIG. 2B) via the light-receiving end 228 and mixes and homogenizes the light. In some examples, the integrator rod 226 includes an aperture (not illustrated) at the light-receiving end 228 to allow entry of the yellow light 220 and the blue light 206 into the integrator rod 226 from the second lens 224. In some examples, the aperture is round; however, other implementations may include an oval, a triangle, a quadrangle, or any other shaped aperture suited for the application. As the yellow light 220 or the blue light 206 travels through the integrator rod 226, the light is reflected by the sides of the integrator rod 226, becoming homogenous. In some examples the integrator rod 226 is a solid glass rod extending between the light-receiving end 228 and a light-transmitting end 230. In some examples, the integrator rod 226 has total internal reflection (TIR) properties that allow the light travelling therein to undergo total internal reflection at the interface between the integrator rod 226 and air surrounding the integrator rod 226. In other examples, the integrator rod 226 is hollow, and mirrored internal surfaces propagate the yellow light 220 or the blue light 206 traveling through the integrator rod 226. In other examples, a reflective film or coating can be provided on exterior surfaces of the integrator rod 226 to reflect the light internal to the integrator rod 226. Other variations may be apparent in light of this disclosure and are intended to be covered by this disclosure. Further, other light-propagating devices may be used, such as, for example, a fly's eye array, or a light tunnel or light pipe (either being hollow or solid) having mirrored or reflective surfaces. The yellow light 220 and the blue light 206 pass through the integrator rod 226 (or other light-propagating device) and out of the light-transmitting end 230 towards the spatial light modulator 130.

According to certain examples, a color filter wheel 232 is optically coupled between the integrator rod 226 and the spatial light modulator 130. In some examples, the color filter wheel 232 has at least two different color segments (first and second segments 234 and 236, respectively, capable of selectively transmitting and reflecting first and second wavelengths of light while permitting a third, different, wavelength to pass therethrough. For example, the first segment 234 may be a magenta filter that transmits red light 244 while reflecting green light 242, and the second segment 236 may be a cyan filter that transmits green light 246 while reflecting red light 240. In this example, both the first and second segments 234, 236 transmit the blue light 206, as shown in FIG. 2B. It should be noted that while the color filter wheel 232 is illustrated as having the first and second segments 234, 236, respectively, additional segments can be included to allow secondary colors through the filter and towards the spatial light modulator 130.

As described above, the yellow light 220 includes the red light 244 and the green light 242. Accordingly, when the yellow light 220 encounters the color filter wheel 232, the red light 240 and the green light 242 reflected from color filter wheel 232 (collectively, the reflected light 248) can be returned to the integrator rod 226, as shown in FIG. 2A. In some examples, an interior surface/face of the light-receiving end of the integrator rod 226 is substantially reflective and reflects the reflected light 248 back towards the light-transmitting end 230. In some instances, the reflective internal surface/face at the light-receiving end 228 reduces the amount of reflected light 248 that travels to the phosphor wheel 204. The light reflected from the internal surface/face of the light-receiving end 228 of the integrator rod 226 is homogenized and directed and transmitted towards the light-transmitting end 230 as recycled yellow light 250.

In some instances, some of the reflected light 248 may travel back towards the phosphor wheel 204 passing through, for example, the other elements of the illumination system 110 in the pathway from the integrator rod 226 to the phosphor wheel 204. For example, reflected light 248 striking the phosphor segment 210 of the phosphor wheel 204 may be reflected back towards the first lens as recycled yellow light 250. The first lens 222 collimates the incoming recycled yellow light 250 (along with the yellow light 220, as described above), and the recycled yellow light passes 250 to the second lens 224 via the dichroic mirror 212. The second lens 224 focuses the collimated recycled yellow light 250 to the light-receiving end 228 of the integrator rod 226, where it may be further homogenized or mixed, as described above. In some instances, the reflected light 248 may strike the pass-through region 208 of the phosphor wheel 204. In such instances, the reflected light 248 may be reflected by the mirrors 214, 216, 218 in the wrap-around path, as is the blue light 206 as described above. However, from the wrap-around path, yellow light may pass through the dichroic mirror 212 towards the laser diode 202. Accordingly, a mirror or other redirecting element (not shown in FIG. 2A) may redirect the yellow light to one of the first or second lenses 222, 224, where it may be directed into the light-receiving end 228 of the integrator rod 226 to become the recycled yellow light 250.

The recycled yellow light 250 may pass through the light-transmitting end 230 of the integrator rod 226 towards the color filter wheel 232. As the recycled yellow light 250 encounters the color filter wheel 232, some of the red and green components are again reflected back to the integrator rod 226 as the reflected light 248, and the process begins anew until the reflected light has dissipated into the ambient. This recycling process improves the efficiency of the system 100 and may improve brightness of the image on the spatial light modulator 130.

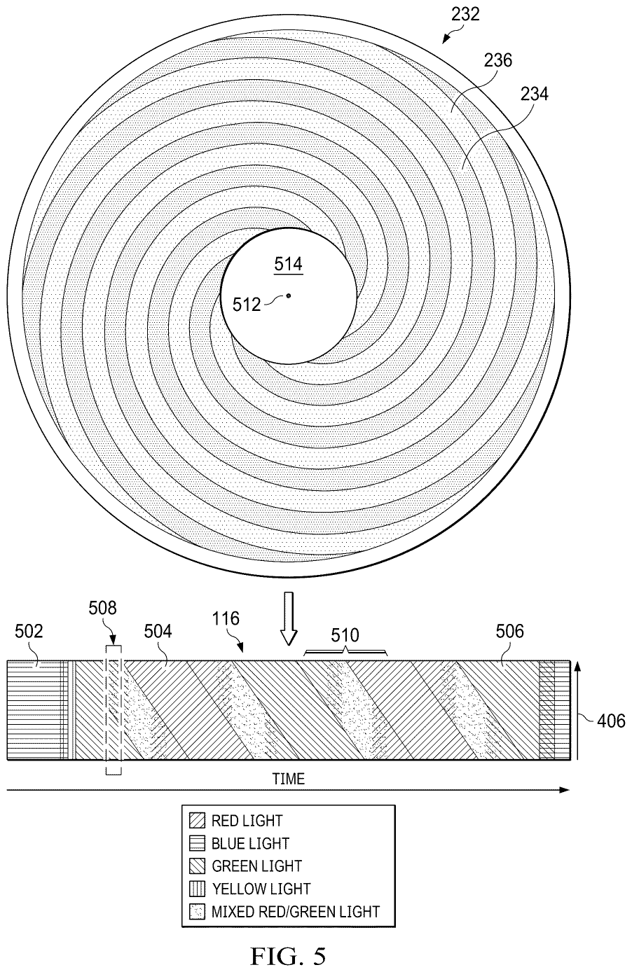

According to certain examples, the color filter wheel 232 rotates in synchronism with the speed of operation of the spatial light modulator 130 to project the red, green, and blue light for integration into a composite color image on the display 140. The color filter wheel 232 may rotate about a center axis (shown as axis 512 in FIG. 5), thereby changing the positions of the color filter segments 234, 236 in the optical path between the integrator rod 226 and the spatial light modulator 130. As described above, rotational speed of the color filter wheel 232 may be controlled by the controller 122, for example. The color filter wheel 232 may rotate at speeds of 60 Hz, 120 Hz, 180 Hz or higher, for example. In some examples, relay optics 252 may be optically coupled between the color filter wheel 232 and the spatial light modulator 130. The relay optics 252 are used to form an image of the rotating filter pattern produced by the color filter wheel 232 onto the spatial light modulator 130. In some examples, the relay optics 252 includes a lens (e.g., as illustrated in FIG. 2B) or multiple lens, such as first and second relay lenses 254, 256 illustrating in FIG. 2A, for example. However, in other examples, the relay optics 252 may include other refractive optics, reflective optics (e.g., one or more mirrors), or a combination of reflective and refractive optical elements.

Referring to FIG. 4, as described above, the spatial light modulator 130 may comprise a two-dimensional array of display elements 402 that can be operated between an ON state and an OFF state. As described above, the spatial light modulator 130 may be a digital micromirror device (DMD) in which the display elements are micromirrors (DMD). A DMD chip may have on its surface several hundred thousand micromirrors arranged in a rectangular (e.g., N×M) array. These micromirrors correspond to the pixels in the image to be displayed, as described above. The micromirrors can be individually rotated, or tilted, to the ON or OFF state responsive to the control signals 126 from the controller 122. In other examples, other types of spatial light modulator devices can be used. For example, liquid-crystal-on-silicon (LCoS) devices can be used. These devices, like the digital micromirror devices, include reflective elements that can be individually controlled to modulate the image into the projected light rays. LCOS are reflective active-matrix liquid crystal displays using liquid crystal on top of silicon. The controller 122 can control properties of the reflective elements to either turn them ON or OFF.

In the ON state, the display elements 402 of the spatial light modulator 130 direct light from the color filter wheel 232 towards the display 110, producing a “bright” pixel in the image on the display. In the OFF state, the light from the color filter wheel 232 is directed elsewhere (usually onto a heatsink), making the pixel appear dark. In some examples, illumination intensity (e.g., brightness of a particular displayed pixel) can be controlled using PWM signals. For example, as described above, the control signals 126 may be PWM signals that specify times/durations for individual display elements 402 of the spatial light modulator 130 to be in the ON state or the OFF state. Assume, for example, a display where images are updated 60 times per second. Each image (or frame) is displayed for approximately 16.7 milliseconds. Given n bits of intensity resolution, the 16.7 millisecond frame period is further divided into 2″−1 time slices for pulse-width intensity modulation, where each time slice is 16.7/(2″−1) milliseconds. For PWM intensity modulation, the data may be formatted into bit planes, where each bit plane corresponds to a bit weight of intensity value. Each bit plane corresponds to an appropriate number of time slices. The higher the bit plane value, the higher the number of time slices used to illuminate the pixel. If each pixel intensity is represented by an n-bit value, then each frame of intensity data has n bit planes.

According to certain examples, the bit planes, and thus the PWM control signals 126, may be generated according to image data representing particular color components of an image to be displayed by the system 100. For example, the PWM control signals may instruct certain display elements 402 of the spatial light modulator 130 to be in the ON state for a certain amount of time when the spatial light modulator 130 is illuminated with light of one color (e.g., green), certain (same or different) display elements to be in the ON state for a some (same or different) amount of time when the spatial light modulator 130 is illuminated with light of another color (e.g., red), and so forth. Accordingly, the PWM control signals 126 for the spatial light modulator 130 may be synchronized with emission of light pulses from the laser diode 202 and with rotation of the phosphor wheel 204 and the color filter wheel 232, such that the spatial light modulator 130 projects the projection beam 132 from the correct display elements 402 for different color components to produce the desired image.

Still referring to FIG. 4, in some examples, data representing the PWM control signals is written to all the (used) display elements 402 of the spatial light modulator 130 at the same time, as described further below. In other examples, data can be written to groups of display elements 402 at a time. In such examples, the display elements 402 may be divided into groups referred to as reset groups 404. In the example illustrated in FIG. 4, the array of display elements 402 of the spatial light modulator 130 is divided into four reset groups 404a-d; however, in other examples, there may be more or fewer than four reset groups 404. Further, in the example illustrated in FIG. 4, the array of display elements 402 is divided by rows, along dimension 406, into the reset groups 404, such that each reset group 404 comprises N rows of display elements 402; however, in other examples, the array may be divided by columns or other groupings of display elements 402.

As described above, as the phosphor wheel 204 rotates (e.g., under control of the controller 122), time slots of the yellow light 220 and blue light 206 are produced at the color filter wheel 232. Similarly, as the color filter wheel 232 rotates, the illumination light 116 transmitted to the spatial light modulator 130 includes time slots of the blue light 206, the red light 244, and the green light 246. An example of the illumination light 116 transmitted from the color filter wheel 232 to the spatial light modulator 130 is illustrated in FIG. 5.

Referring to FIG. 5, there is illustrated a plan view of the color filter wheel 232, according to one example, and an example of the illumination light 116 output from the color filter wheel 232. In the illustrated example, the color filter wheel 232 is implemented as an involute color filter. The color filter wheel 232 rotates about its central axis 512, as described above. As shown, the color filter wheel 232 has an involute color structure in the form of an involute of a circle including ten equal segments alternating between the first segment 234 and the second segment 236. In this example, each of the segments 234 and 236 is laid out as a spiral with each spiral abutting the adjacent spiral. Each spiral is defined by the following equations: xi=a*(cos(t)+t*sin(t)) and yi=a*(sin(t)−t*cos(t)) with “x” and “y” being spatial dimensions of the color filter wheel 232, “a” being a variable curve parameter that can be adjusted based on the number of segments 234, 236, the diameter of the color filter wheel 232 and the diameter of the center cutout 514, and “t” is a parametric equation parameter that can range from 0 to infinity. In other examples, the color filter wheel 232 may have a different filter structure, such as an Archimedean color filter or other non-involute color filter.

According to certain examples, the color filter wheel 232 outputs filtered light to produce the illumination light 116 in a pattern of color time slots. The color (or wavelength range) of each color time slot may depend on the rotation of the phosphor wheel (e.g., whether the blue light 206 or the yellow light 220 is incident on the color filter wheel 232) and the rotation of the color filter wheel 232 itself (e.g., whether the incident light encounters the first segment 234 or the second segment 236). For example, as shown in FIG. 5, the illumination light 116 may include one or more blue time slots 502, red time slots 504, and green time slots 506. For the illumination light 116 shown in FIG. 5, the color time slots 502, 504, 506 are arranged in a pattern over time (with time illustrated along the horizontal dimension), and the vertical dimension represents the distribution of the illumination light 116 over the spatial light modulator 130 along the dimension 406. Thus, at any given point in time, a vertical “slice” 508 taken through the pattern of the illumination light 116 shown in FIG. 5 represents the distribution of colored light across the dimension 406 of the spatial light modulator 130. As shown in FIG. 5, due to the spiral arrangement of the first and second segments 234, 236 of the color filter wheel 232, the transitions between illuminating the spatial light modulator 130 with the red light 244 (e.g., red time slots 504) and illuminating the spatial light modulator 130 with the green light 246 (e.g., the green time slots 506) are spread over time and over the dimension 406 of the spatial light modulator 130, leading to “mixed” color time slots 510. Thus, during a color transition, one region of the spatial light modulator 130 (e.g., the reset group 404a) may be illuminated with the red light 244, while at the same time, another region of the spatial light modulator 130 (e.g., the reset group 404d) may be illuminated with the green light 246. Further, during a color transition, one or more regions of the spatial light modulator 130 (e.g., one or more reset groups 404) may be illuminated with a blend of the red light 244 and the green light 246 (e.g., with some shade of yellow light, depending on the relative mix of red and green). These transitions, or mixed color time slots 510, are referred to as spokes.

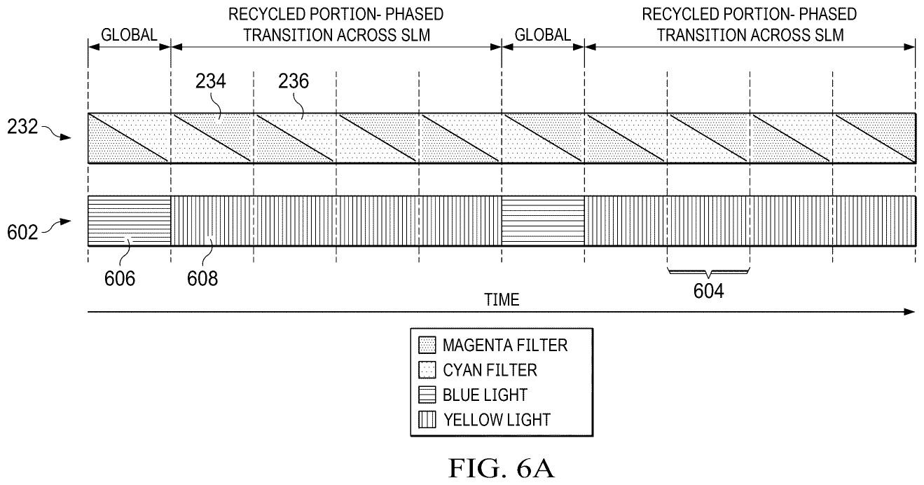

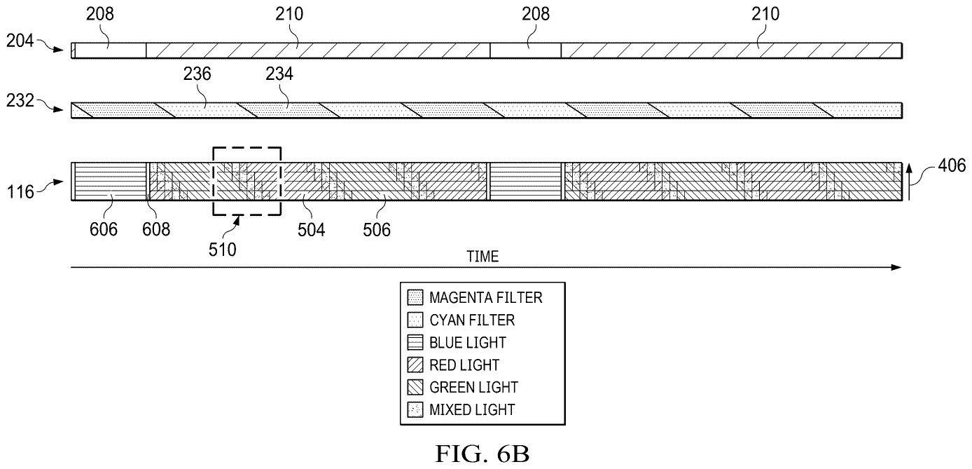

Turning to FIGS. 6A and 6B, generation of the illumination light 116 using an example of the phosphor wheel 204 illustrated in FIG. 3 and the color filter wheel 232 illustrated in FIG. 5 is further described and illustrated. Referring to FIG. 6A, an example of a light pattern 602 output over time from the phosphor wheel 204 and incident at the color filter wheel 232 is illustrated. The light pattern 602 is shown for one complete rotation of the phosphor wheel 204. In this example, the light pattern 602 is shown divided, or segmented, into a plurality of color time slots 604, with each time slot 604 corresponding to the duration of a blue time slot 606 (e.g., the duration of time for which one pass-through region 208 of the phosphor wheel 204 is positioned in the optical path). Thus, for one complete rotation of the phosphor wheel 204 of FIG. 3, the light pattern 602 includes two blue time slots 606 and eight yellow time slots 608, as shown. As also shown in FIG. 6A, and described above, the color filter wheel 232 includes alternating regions of the first segment 234 (magenta filter in this example) and the second segment 236 (cyan filter in this example). For the spiral arrangement of the first and second segments 234, 236 shown in FIG. 5, the first and second segments 234, 236 are “angled” across the path of the light pattern 602. Thus, for one time slot 604, a spatial portion (e.g., vertical extent in the example illustrated in FIG. 6A) of the light pattern 602 encountering the first segment 234 may decrease over time, while an inverse spatial portion of the light pattern 602 encountering the second segment 236 may increase correspondingly over time, or vice versa. Accordingly, as the yellow light 220 from the phosphor wheel 204 encounters the color filter wheel 232, the transition from the red light 244 being output by the color filter wheel 232 to the green light 246 being output by the color filter wheel 232 is spread over time across the spatial extent of the illumination light 116, as illustrated in FIG. 6B, leading to the creation of the spokes 510.

Continuing with the example of FIGS. 6A and 6B, since both magenta and cyan filters allow the passage of blue light, the blue time slots 606 in the illumination light 606 may cover the full vertical extent (e.g., along the dimension 406) of the spatial light modulator 130. Transitions to and from illumination of the spatial light modulator 130 with the blue light 206 may thus be considered “global” as they may occur across the whole array of display elements 402 (e.g., over all reset groups 404) at the same time. As shown in FIG. 6B, the boundaries in time of the blue color slots 606 are substantially vertical (e.g., substantially parallel to the dimension 406). In contrast, during the yellow time slots 608, where light recycling is occurring as described above, the resulting transitions between red and green light (e.g., between red time slots 504 and green time slots 506) in the illumination light 116 are phased across the spatial light modulator in the dimension 406. That is, as the color filter wheel 232 rotates, one (or more) reset group(s) 404 of the spatial light modulator 130 may experience the transition from illumination with the red light 244 to illumination with the green light 246 (or vice versa) earlier in time than other reset groups 404. Accordingly, the red time slots 504 and the green time slots 506 have a “parallelogram” shape in the illustration of FIG. 6B, rather than the rectangular shape of the blue time slots 606.

In some examples, because both magenta and cyan filters allow the passage of the blue light 206, there may be no perceivable transitions within the blue time slots 606 as the color filter wheel 232 rotates. However, rotation of the phosphor wheel 204 may result in a blue to yellow (or vice versa) transition. According to certain examples, to ensure spatial color linearity across the recycling portion illumination light 116 (e.g., the portion corresponding to illumination of the color filter wheel 232 with the yellow time slots 604), it may be preferable to ensure that no blue light 206 is included in the illumination light 116 during this portion. Accordingly, the pass-through region 208 on the phosphor wheel 204 may be made slightly to accommodate blue transition spokes 608 on either side of the blue time slots 606. These blue transition spokes 608 may result from the blue/yellow transitions in illumination on the color filter wheel 232 due to rotation of the phosphor wheel 204, as described above.

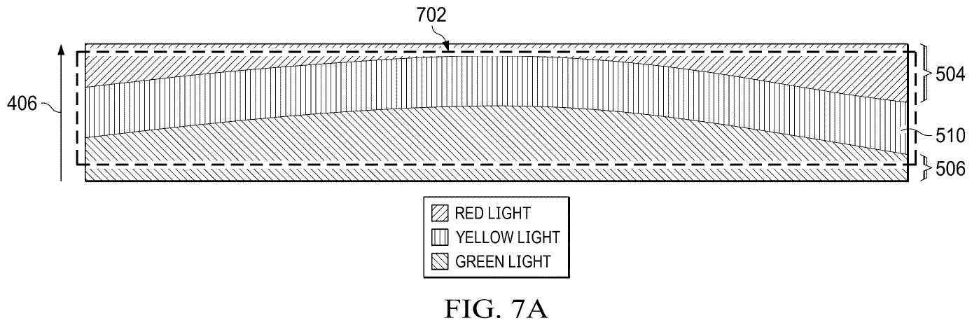

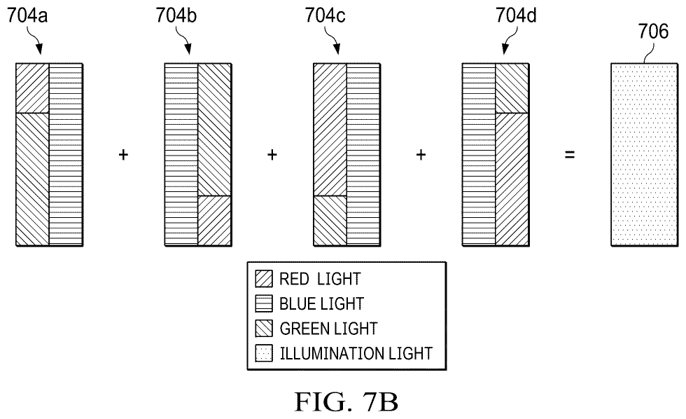

As described above, in some examples, the first and second segments 234, 236 on the color filter wheel 232 have curved boundaries (e.g., are spirals as shown in FIG. 5 and described above). In some such examples, the spokes 510 corresponding to red-to-green light and green-to-red light transitions discussed above are curved, following the curvature of the first and second segments 234, 236 on the color filter wheel. Accordingly, the image of these spokes 510 on the spatial light modulator 130 may similarly follow the curvature of the first and second segments 234, 236. However, as described above, the spatial light modulator 130 may include a rectangular array of display elements 402, as shown in FIG. 4, for example. In some cases, loading data in a curved fashion (e.g., to follow the curved profile of the spokes 510) onto a rectangular array of display elements 402 cannot be practicably accomplished. Accordingly, the spokes 510 may be approximated by a bounding rectangle. An example is illustrated in FIG. 7A.

Referring to FIG. 7A, a spoke 510 between a red time slot 504 and a green time slot 506 is illustrated. The spoke 510 may be approximated by a bounding rectangle 702. However, as shown in FIG. 7A, in some examples, the spoke 510 may not have a uniform curvature from left to right (or vice versa) across the array. Therefore, the approximation of the spoke 510 using the bounding rectangle 702 may result in red-to-green spokes and green-to-red spokes having different color profiles from top to bottom (e.g., along the dimension 406 of the spatial light modulator 130). This difference may lead to what is known as the “venetian blind effect” as the spokes 510 move across the array in the direction of dimension 406, which may cause unpleasant human-perceptible “striping” or other color artefacts in the displayed image.

To compensate for this effect, the color filter wheel 232 and the phosphor wheel 204 can be constructed and controlled such that, during any given frame period, an equal number of red-to-green and green-to-red spokes are imaged on the spatial light modulator 130. Accordingly, pairs of complementary spokes may be combined during the frame period to produce spatially linear light. In particular, the complementary red/green transition pairs may produce uniform yellow light, thereby removing the curvature of the spokes 510 as imaged onto the spatial light modulator 130. This configuration can be extended to also account for the blue transition spokes 608 described above.

FIG. 7B illustrates an example of combining, during a given frame period, complementary sets of color transitions to produce spatially uniform (linear) illumination light 706 that is a certain shade of gray. In the illustrated example, panel 704a represents a blue time slot followed by a red to green transition, while panel 704c shows the blue time slot followed by a complementary green to red transition. Panels 704b and 704d show the other two complementary transitions-a red to green transition followed by a blue time slot (panel 704b) and green to red transition followed by a blue time slot (panel 704d). Thus, the combination, or integration, of the four complementary transitions represented in panels 704a-d over a frame period produce the spatially uniform gray illumination light 706.

To achieve proper combinations of complementary color transitions over a frame period resulting in the spatially uniform perceived illumination light 706, the phosphor wheel 204 and the color wheel 232 may be configured and controlled (e.g., in rate of rotation) to produce a particular pattern of color time slots and color transitions in the illumination light 116 over a given frame period. In particular, the phosphor wheel 204 and the color filter wheel 232 can be configured with specific color segment sizes and a specific arrangement (or ordering) of color segments to produce the illumination light 116 at the spatial light modulator 130 with spatial color linearity. For example, referring again to FIG. 6A, a complete frame period may be represented by one or more global color time slots (e.g., at least one blue time slot 606) and a recycling portion of the light, namely one or more yellow time slots 608. Within the recycling portion of light for a given frame period, to avoid the venetian blind effect described above, there should be an equal number of red and green time slots with complementary transitions. For example, one pattern for a frame period of the illumination light 116 may be: BRGBGR (where B=the blue light 206, R=the red light 244, and G=the green light 246), or another pattern may be: BRGRGBGRGR. In either case, the pattern of the illumination light 116 includes (for a given frame period) an equal number of red and green time slots 504, 506 (R and G) and an equal number of red-to-green (RG) and green-to-red (GR) transitions. Accordingly, a combination of the complementary spokes during the frame period may produce spatially uniform light of a particular shade of gray, as described above. It will be appreciated that any number of red and green time slots may follow each blue time slot, provided that there is an equal number of red time slots 504 and green time slots 506 and an equal number of complementary transitions.

Thus, in some examples of the system 100 where the light source 112 can be configured to emit first light having a first color (e.g., the laser diode 202 emits the blue light 206, as described above), the rotatable phosphor wheel 204 is optically coupled to the light source 112, and the rotatable color filter wheel 232 is optically coupled to the phosphor wheel 204, the system can be configured to produce the illumination light 116 avoiding the venetian blind effect, as described above. For example, the phosphor wheel 204 may comprise a first segment (e.g., the pass-through region 208) configured to transmit the first light (e.g., the blue light 206) and a second segment (e.g., the phosphor segment 210) configured to emit, responsive to the first light, second light having a second color (e.g., the yellow light 220), and the color filter wheel 232 may comprise a third segment (e.g., segment 234) configured to transmit the first light and a first component of the second light (e.g., the red light 244) and to reflect a second component of the second light (e.g., the green light 246), and a fourth segment (e.g., segment 236) configured to transmit the first light and the second component of the second light and to reflect the first component of the second light, wherein the first component of the second light has a third color (e.g., red) and the second component of the second light has a fourth color (e.g., green). In some such examples of the system 100, the controller 122 may be configurable to synchronize rotation of the phosphor wheel 204 and the color filter wheel 232 to cause the color filter wheel 232 to transmit filtered light in a pattern of color time slots, wherein the pattern of color time slots comprises a first time slot of the first color (e.g., blue), followed by a first series of alternating time slots of the third color (e.g., red) and the fourth color (e.g., green), followed by a second time slot of the first color (e.g., blue), followed by a second series of alternating time slots of the fourth color (e.g., green) and the third color (e.g., red).

As described above with reference to FIG. 6B, in some examples, transitions between red and green light (e.g., between red time slots 504 and green time slots 506) in the illumination light 116 are phased across the spatial light modulator in the dimension 406, such that at a given point in time, different reset groups 404 may be illuminated with light of different colors. For example, for a transition from red to green illumination, one or more reset groups may start to be illuminated with green light while one or more other reset groups are still being illuminated with red light. Accordingly, certain examples described herein provide techniques for generating and applying the PWM control signals 126 to account for this variation in illumination colors over the spatial light modulator 130 and the presence of the spokes 510.

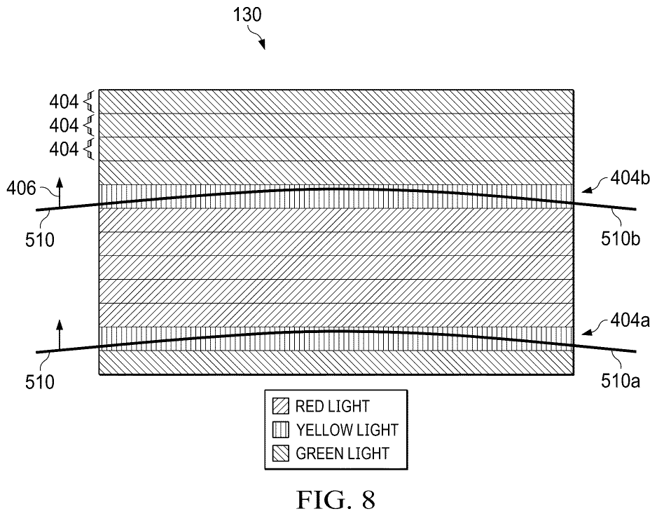

Turning to FIG. 8, there is illustrated a portion of the spatial light modulator 130 including a plurality of reset groups 404 and showing a representation of movement of spokes 510 over time across the spatial light modulator 130 in the direction of dimension 406 (e.g., from bottom to top). The spatial light modulator 130 is shown illuminated by the illumination light 116 during a recycling portion of a frame period (e.g., when the yellow light 220 is illuminating the color filter wheel 232). In this example, the color transitions occur over time from the bottom of the spatial light modulator 130 to the top. That is, lower reset groups (e.g., 404a) experience the color transition, or spoke, before higher reset groups (e.g., 404b). Thus, in the illustrated example, two spokes 510 are shown, namely a first spoke 510a representing a transition from the red light 244 to the green light 246 and a second spoke 510 representing a transition from the green light 246 to the red light 244.

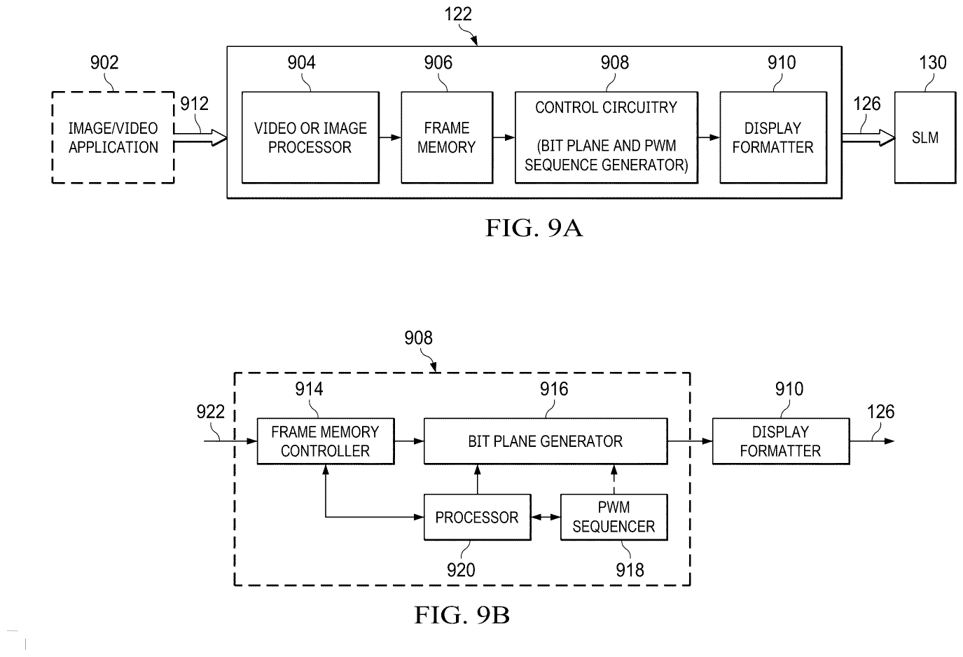

As described above, in some examples, the PWM control signals 126 that control the ON/OFF states of the display elements 402 of the spatial light modulator may be derived from image data associated with different color components of an image frame to be displayed. Accordingly, the control signals 126 applied to control display elements 402 illuminated with one color of light (e.g., those in reset group(s) 404 illuminated with the green light 246) may need to be different from those applied to control display elements 402 illuminated with a different color of light (e.g., those illuminated with the red light 244). Phrased another way, certain reset groups 404 may be illuminated with light of a certain color (and therefore need to be controlled according to one or more particular control signals 126) sooner than other reset groups 404 as the transition from one color to another moves across the spatial light modulator over time. Accordingly, in certain examples, the controller 122 can be configured to structure the control signals 126 and/or to time provision of the control signals 126 to various portions (e.g., reset groups) of the spatial light modulator so as to account for varying illumination over the spatial light modulator 130. FIGS. 9A and 9B are block diagrams illustrating components of the controller 122 that can be configured to produce the control signals 126 in the form of PWM sequences to control the spatial light modulator 130 according to various techniques described herein.

Referring to FIG. 9A, in some examples, the controller 122 is configured to receive image data from an image or video application 902 in the form of image or video signals 912 and to process the image data to provide processed image data. The controller 122 sends the processed image data in the form of the control signals 126 (e.g., voltage signals) to the spatial light modulator 130 to control the spatial light modulator to project the respective images, as described above. The image data may include digital data that represents images encoded according to a suitable image or video encoding standard. The image or video signals 912 may be any signal received on a physical interface for transferring image data, such as a high-definition multimedia interface (HDMI) interface, a display serial interface (DSI) interface, a flat panel display (FPD) interface, a parallel red, green and blue (RGB) interface, or other suitable interfaces for transferring image data. After processing the image data, the controller 122 may send the control signals 126 carrying the processed image data to the spatial light modulator 130. For example, the control signals 126 may be voltage signals provided according to a low voltage differential signaling (LVDS), a reduced LVDS (Sub-LVDS), a parallel pixel (I/F) signal, or any suitable voltage signal for controlling the spatial light modulator 130 to project the images.

According to certain examples, the controller 122 includes a video or image processor 904, a frame memory 906, control circuitry 908, and a display formatter 910. The components of the controller 122 may be implemented via hardware, software, or combinations thereof. Two or more of the components of the controller 122 may be combined into a single integrated component. The video or image processor 904 may convert the image or video signals 912 into the image data. The image data may be digital data arranged in a time sequence of image frames. In some examples, the video or image processor 904 may compress the image data into digital data of multiple image frames. The video or image processor 904 may be coupled to the frame memory 906 and sends a sequence of the image frames to the frame memory 906 which stores the image frames. The image frames may be processed and stored at a certain frame rate according to the time sequence of image frames received from the image or video application 902, for example. The frame memory 906 may store the image frames in a compressed or uncompressed format. The control circuitry 908 may be coupled to the frame memory 906 and to the display formatter 910. The control circuitry 908 may retrieve image frames, or image data derived from processing respective image frames, and process the information contained therein. In particular, the control circuitry 908 may produce PWM sequences that are formatted by the display formatter 910 to produce the control signals 126.

Referring to FIG. 9B, in some examples, the control circuitry 908 includes a frame memory controller 914, a bit plane generator 916, a PWM sequencer 918, and a processor 920. Although illustrated as separate components in FIG. 9B, any of the frame memory controller 914, the bit plane generator 916, the PWM sequencer 918, and/or the processor 920 may be combined into one or more circuits, processors, or combinations thereof. The frame memory controller 914, the bit plane generator 916, and the PWM sequencer 918 represent functional aspects of the control circuitry 908 that may be implemented in hardware, software, or a combination thereof.

According to certain examples, the frame memory controller 914 accesses stored image frames from the frame memory 906 to extract image data that is used to produce the control signals 126. The image data may include intensity data that describes, for individual pixels in an image frame, the intensity of a given color for a respective pixel. As described above, an image frame to be displayed by the system 100 on the display 140 includes multiple pixels that may correspond to the display elements 402 of the spatial light modulator 130. Individual pixels in the image frame may include multiple color components, such as red, green, and/or blue, that represent color shades of the image with particular intensities. A pixel of the displayed image is a projection of the pixel of the image frame in the image data that is used to produce the control signals 126 for the spatial light modulator 130. The color shades and intensities (e.g., brightness) of displayed pixels are the combined projection (e.g., over a time sequence) of the color components of the respective pixels. As also described above, the display elements 402 of the spatial light modulator 130 can be operated between an ON state (maximum intensity) and an OFF state (minimum, generally zero, intensity). PWM can be used to produce intermediate intensity levels. Specifically, each display element 402 of the spatial light modulator 130 can be turned ON and OFF at a rate faster than the human eyes can perceive, such that the corresponding displayed pixel in the image appears to have an intermediate intensity proportional to the fraction of the time when the display element 402 is ON.

According to certain examples, each pixel in an image frame is represented by a plurality of data bits, with each data bit having a significance (e.g., the data bits may be arranged in a data word from a most significant bit (MSB) to a least significant bit (LSB)). The number of data bits (e . . . , 4, 5, 8, 10, etc.) determines the number of gray shades that can be described for each pixel, and is referred to as the bit depth. For example, using 8 data bits per color component per pixel allows for up to 256 shades of the color component to be displayed. Each time the corresponding display element 402 of the spatial light modulator 130 is addressed (e.g., via a control signal 126), the value of the current pixel data bit determines whether the addressed display element 402 is ON or OFF, and the bit significance determines the duration of the display element at the ON-state or the OFF-state. A collection of pixel data bits of the same significance for the image pixels is referred to as a bit plane. A PWM sequence refers to the process of displaying the bit planes derived from the image data for a given image frame based on PWM of the display elements 402 of the spatial light modulator 130. Thus, to produce PWM sequences for controlling the spatial light modulator 130, the control circuitry 908 may perform at least two processes. At the bit plane generator 916, the image data for a respective image frame is rearranged into bit planes, as described further below. In some examples, the bit plane generator 916 produces one or more bit planes for each color component of the pixels of the image frame, with the number of bit planes being determined by the number of data bits representing individual pixels. The bit planes may have a binary or non-binary format. At the PWM sequencer 918, the frame period (e.g., the time for which the image frame is to be projected by the spatial light modulator 130 for display on the display 140) is divided into fixed periods of time referred to as bit segments. Each bit segment may be assigned to a single bit plane. Bit planes for collections of higher-significance data bits may be assigned to bit segments of longer duration.

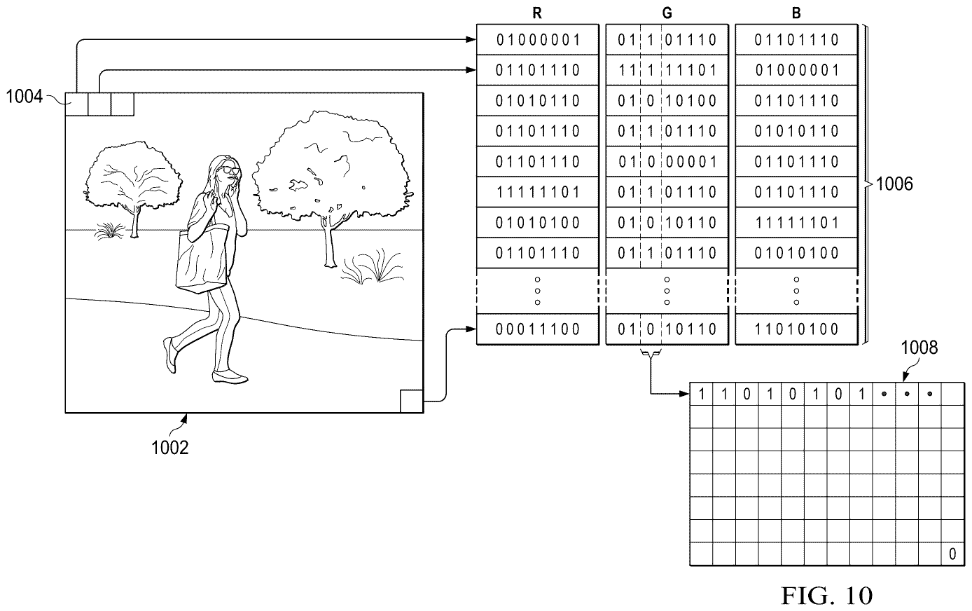

Referring to FIG. 10, an example of a process of producing bit planes for an image frame 1002 is illustrated. The image frame 1002 includes a plurality of pixels 1004. In the image data 1006, each pixel 1004 is described by a certain number of bits for each color component (e.g., R, G, and B). A bit plane 1008 is generated by grouping bits with the same bit number (same significance) from the collection of pixels 1004 of the image frame 1002. For example, if the image data 1006 includes, for each pixel 1004, eight bits for a certain color component, the first bits in the eight bits (e.g., the MSBs or LSBs) are collected for all the pixels and grouped to form a first bit plane for that color component. For example, FIG. 10 illustrates formation of the bit-5 bit plane for the green (G) color component. This process can be repeated for each bit number to obtain eight bit planes for the same color component. Similarly, eight bit planes can be formed for each color component. For example, if the pixels of an image frame are represented by three color components each represented by eight bits, the number of generated bit planes is equal to twenty four. Thus, a first bit plane may be generated by grouping the first bits of the first color component in the set of pixels, a second bit plane may be generated by grouping the second bits of the first color component, and the remaining bit planes may be generated similarly for the remaining bits of the remaining color components in the set of pixels. Although the example illustrated in FIG. 10 uses eight bits per color component of each pixel 1004, in other examples, the image data 1006 may include any M number of bits for a certain color component of each pixel 1004, and the number of bit planes may be equal to any N number of bit planes, where M and N are positive integers. For example, the N bit planes can be generated for the M bits of the color component using one or more M-to-N transfer functions.

The bit planes generated by the bit plane generator 916 may be assigned to bit segments of the frame period according to pulse wave signals from the PWM sequencer 918. In some examples, the bit planes can be weighted proportional to the duration of time for which each bit plane is to be displayed at the spatial light modulator 130. The bit planes may be formatted/arranged into sequences for display. For example, in some instances, rather than displaying all the bit planes precisely in the order of bit significance, improved image quality can be achieved by interleaving the bit planes. The formatted bit plane sequences may be sent from the bit plane generator 916 to the display formatter 910, which converts the bit planes into a signal format, such as voltage signals, suitable for controlling the spatial light modulator 130.

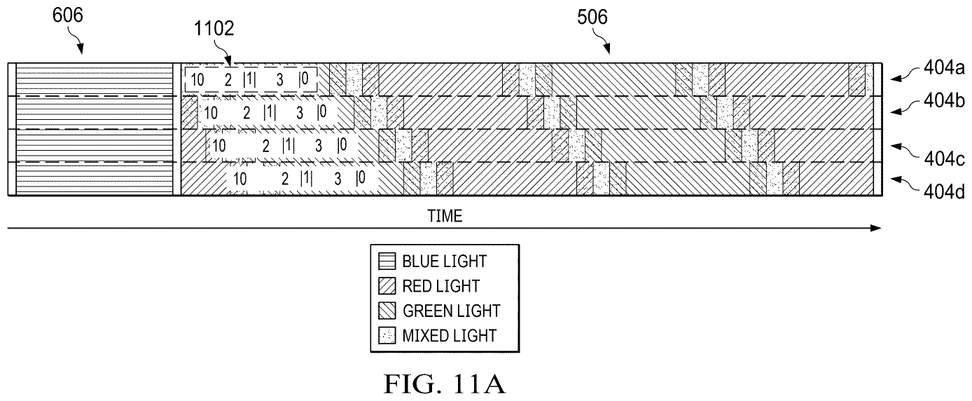

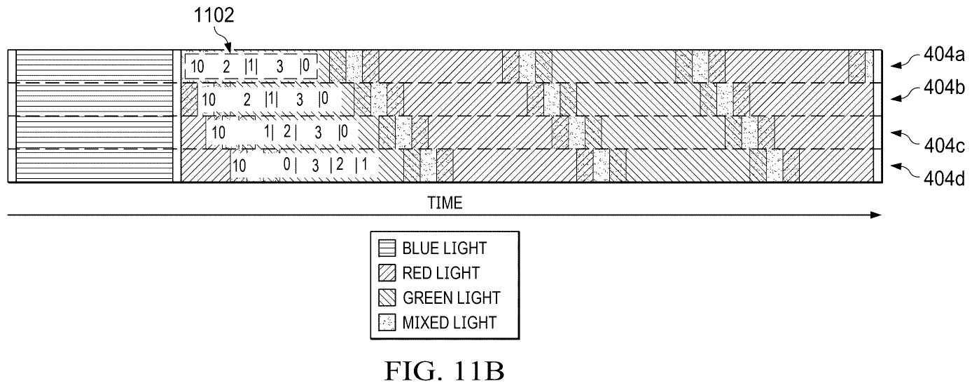

Turning to FIGS. 11A and 11B, in some examples, because the bit planes are produced for particular color components of the image frame, it is preferable to synchronize the loading of particular bit plane sequences to the spatial light modulator 130 with illumination of the spatial light modulator 130 with the corresponding color of light. Referring to FIG. 11A, as described above, in some instances, such as in the case of illumination with a blue time slot 606, the illumination may be global across the spatial light modulator 130. Accordingly, the bit plane sequences for the blue color segment may be loaded to the complete array of the spatial light modulator (e.g., all reset groups 404) at the same time. However, as shown in FIG. 11A, and as discussed above with reference to FIGS. 5 and 6B, for example, during the light-recycling portion of illumination (e.g., with the yellow light 220 and the recycled yellow light 250), the transitions (spokes) between illumination with the red light 244 and illumination with the green light 256 may be phased across the spatial light modulator 130. Thus, the reset group 404a may start receiving green illumination light sooner than does reset group 404b, which starts receiving the green illumination light sooner than does reset group 404c, which starts receiving the green illumination light sooner than does reset group 404d. The time delay between when the different reset groups 404a-d start to be illuminated with the red light 244 or the green light 246 may depend on the size of the reset groups (e.g., how many rows of display elements 402 are in each reset group 404) and the speed of rotation of the color filter wheel 232.

Accordingly, in certain examples, the controller 122 can be configured to load a bit plane sequence 1102 for a green illumination time slot 506 in a “staggered” fashion across the reset groups 404a-d. That is, rather than loading the bit plane sequence 1102 to all the reset groups 404a-d at the same time (as may be done during a global load for the blue time slot 606, for example), copies of the bit plane sequence 1102 may be loaded to individual reset groups at respective time intervals, with a time delay between successive time intervals. The time delays can be synchronized with rotation of the color filter wheel 232 such that bit plane sequence 1102 is loaded to individual reset groups at the appropriate time (e.g., while the respective reset group is illuminated with the green light 246, for example). Thus, output of the bit plane sequences from the bit plane generator 918, and/or output of the corresponding voltage signals from the display formatter 910, can be controlled to match, or be synchronized with, movement of spokes across the spatial light modulator 130. In particular, in certain examples, the processor 920 may control the bit plane generator 918 to produce and/or output multiple copies of any particular bit plane sequence, with the copies being output staggered in time (e.g., delayed relative to one another) to track the rate at which a spoke travels across the reset groups 404 of the spatial light modulator 130. Thus, different bit planes (representing different image content) may be displayed by different reset groups 404 over time. This approach may be referred to as using phased reset groups, or phased control of reset groups, that matches the phasing of the color transitions over the spatial light modulator 130, as described above.

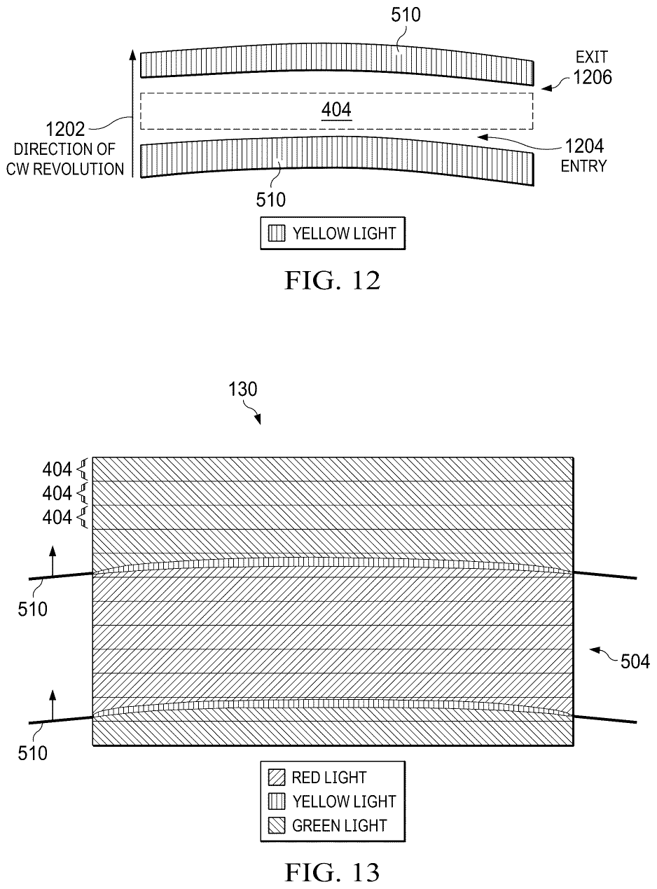

Referring to FIG. 12, there is illustrated a representation of movement of a spoke 510 over a reset group 404 of the spatial light modulator 130. Direction of rotation of the color filter wheel (and therefore of the movement of the spoke 510) is represented by arrow 1202. From a PWM sequence perspective, the size of the spoke 510 may be measured from the time at which any part of the spoke 510 enters a reset group 404 to the time that all parts of the spoke 510 leave the reset group 404. As described above, in some examples, the spokes 510 have a curved profile, and therefore, the first entry point 1204 of the spoke 510 into the reset group 404 is not the same as the last exit point 1206 of the spoke 510 from the reset group 404. Accordingly, in some examples, the size of the spoke 510 may be determined by the sum of the time taken for the spoke 510 to cross one reset group 404 and the height of the spoke (e.g., measured in the dimension of arrow 1202) in units of time, such as microseconds, for example. With a known spoke size, relative to the reset groups 404 of the spatial light modulator, the time delays between the output of successive copies of a given bit plane sequence can be set to track the movement of the spokes 510 over the spatial light modulator 130. Thus, individual reset groups 404 can be loaded with bit planes that match the color of illumination light received at the respective reset groups over time. According to certain examples, the arrangement and/or sizing of the color segments 234, 236 on the color filter wheel 232, and/or the arrangement and/or sizing of the pass-through region(s) 208 and phosphor region(s) 210 on the phosphor wheel 204 can be selected to minimize the spoke size. In examples in which the primary color components of the image data are red, green, and blue, for example, reducing or minimizing the spoke size can be advantageous in that doing so minimizes the time that the spatial light modulator 130 may be illuminated with yellow light, rather than useful red or green light.

In some instances, some data bits at the beginning and end of a PWM sequence may be needed for timing and control signals that define the start and end of a light projection cycle using a particular color, or colors, of illumination light. These bits are referred to as “bookend” bits. In some examples, using the phased reset group approach described herein may avoid the need for such bookend bits for the light-recycled portion(s) of the frame period as the color transitions are tracked across the spatial light modulator, as described above.

Referring again to FIGS. 11A and 11B, as described above, the bit plane sequence 1102 may include an arrangement of weighted bit planes that, when integrated over time, represent particular color shades and brightness of the pixels of the displayed image. For example, the bit plane sequence 1102 shown in FIGS. 11A and 11B includes weighted bit planes represented by the numbers 10, 2, 1, 3, and 0. The higher the number, the greater the weight of the corresponding bit plane, meaning that the bit plane will be displayed at the spatial light modulator 130 for a longer period of time. The order in which the bit planes of a particular bit plane sequence are displayed may not be of particular importance, provided that each bit plane is displayed for the correct amount of time. In some instances, a bit plane can only be loaded to one reset group 404 of the spatial light modulator 130 at any given moment in time. Thus, considering the staggered copies of the bit plane sequence 1102 shown in FIG. 11A, the starting point in time (e.g., the load time) for a particular bit plane in one copy of the bit plane sequence for one reset group cannot overlap in time with the load time for any bit plane in another copy of the bit plane sequence 1102 at another reset group. Such overlaps in load times are referred to as load conflicts. Thus, for example, if loading of the bit plane “2” at reset group 404c overlaps in time with loading of the bit plane “1” at reset group 404b, this would represent a load conflict.

To avoid such load conflicts, the bit planes in various copies of the bit plane sequence 1102 can be rearranged, or reordered, as illustrated in FIG. 11B. For example, as shown in FIG. 11B, the bit plane sequence 1102 for reset groups 404a and 404b has the order 10, 2, 1, 3, 0; whereas the copy of the bit plane sequence for reset group 404c is reordered to 10, 1, 2, 3, 0, and the copy of the bit plane sequence for reset group 404d is reordered to 10, 0, 3, 2, 1. In this manner, load conflicts among reset groups 404 can be avoided. It will be appreciated that the example shown in FIG. 11B is merely illustrative and numerous variations may be implemented. In some examples, the processor 920 may resolve potential load conflicts. For example, the bit plane generator 918 may generate a bit plane sequence (e.g., bit plane sequence 1102) for a given color component of an image frame, and the processor 920 may determine the number of copies of the bit plane sequence needed (e.g., based on the number of reset groups 404 in the spatial light modulator 130 and/or the rate of rotation of the color filter wheel 232) and the time delay needed between output of successive copies of the bit plane sequence (e.g., based on the size of the reset groups and the rate of rotation of the color filter wheel 232). The processor 920 may then evaluate whether any potential load conflicts exist based on the time points at which individual bit planes of the multiple copies of the bit plane sequence would be loaded to the respective reset groups of the spatial light modulator 130, and reorder any one or more copies of the bit plane sequence, as needed, to resolve any load conflicts.

Thus, according to certain examples, the frame memory controller 914 may obtain image data from the image frame, the image data being associated with a color component of the image frame, and the bit plane generator 916 produce a bit plane sequence responsive to the image data. The controller 122 may then output multiple copies of the bit plane sequence to the spatial light modulator 130 at respective multiple time intervals with a time delay between respective time intervals being synchronized with a rate of rotation of the color filter wheel 232. This process may be repeated for multiple color components of the image frame. In this manner, during the light-recycling portion of a frame period, individual reset groups 404 of the spatial light modulator can receive bit plane sequences for particular color components of the image data as the reset groups are illuminated with light of the corresponding color. Thus, the reset groups “track” the color transitions across the spatial light modulator and color transition artifacts associated with the spokes can be minimized.

According to other examples, the presence of spokes 510 during the light-recycling portion of the frame period can be handled by configuring the controller 122 to produce multi-color bit plane sequences. In the examples described above, the control circuitry 908 produces bit planes for individual color components of the image data. These color-specific bit planes can then be loaded to different reset groups 404 of the spatial light modulator 130 in a time-delayed manner that tracks the phasing of the spokes 510 over the spatial light modulator 130 as described above. In other examples, the processor 920 may be programmed with, or configured to determine, a geometric description of the spokes on the spatial light modulator 130, along with timing information that describes the rate at which the spokes 510 move across the spatial light modulator 130 as the color filter wheel 232 and the phosphor wheel 204 rotate. The processor 920 and the bit plane generator 918 may be configured to produce, based on the geometric description of the spokes and the timing information, multi-color bit plane sequences that account for color variations in illumination across the spatial light modulator 130 due to the spokes 510.

According to certain examples, a parametric description of the spokes 510 can be used to describe the location of spokes in time and space on the spatial light modulator 130. For example, a parametric function, f(x,y,t)=color, may describe the distribution of illumination over the spatial light modulator, where x and y are spatial coordinates on the spatial light modulator 130 (e.g., row and column positions of display elements 402), t is time, and color is red, green, or yellow. Using the parametric function, image data for red, green, and/or yellow color components of pixels corresponding to each display element 402 can be used to generate bit planes, as described above. Thus, in some examples, each multi-color bit plane may represent a “snapshot” in time of the illumination over the entire spatial light modulator 130 resulting from the relative positions, and configurations, of the phosphor wheel 204 and the color filter wheel 232.

As described above with reference to FIG. 5, the arrangement of the color segments 234, 236 on the color filter wheel 232 can be described parametrically based on the geometry of the color filter wheel 232. For example, as described above, where the color filter wheel 232 is configured as the involute of a circle, the positions of the spiral color segments 234, 236 can be described by the equations:

$$xi = a * ( cos ( t ) + t * sin ( t ) ) , and$$

$$yi = a * ( sin ( t ) - t * cos ( t ) ) ,$$

where “x” and “y” are spatial dimensions of the color filter wheel 232, and “a” and “t” are parametric variables. As these equations describe the positions of the spiral color segments 234, 236, they also describe the positions of the spokes 510 imaged onto the spatial light modulator 130 when the color filter wheel 232 is illuminated with the yellow light 220 and recycled yellow light 250.

Accordingly, referring to FIG. 13, for example, the equations may define, for any given point in time during the color recycling portion of the frame period (when the color filter wheel 232 is illuminated with yellow light), which reset groups 404 (or which individual display elements 402, rows of display elements, or columns of display elements) are illuminated with red, green, or yellow light. Similarly, parametric equations can describe the spatial positioning of the spokes 510, over time, for other geometries of the color filter wheel 232. Accordingly, bit planes representing the appropriate color component(s) of the image data can be generated according to the processes described above, or variations thereof. In some examples, because the parametric equations describe the spoke positions in terms of individual display elements 402, there is no need to produce rectangular approximations of the spokes 510. Curved spokes can be described and tracked across the spatial light modulator to a resolution of one display element 402. It will be appreciated that, in some examples, a complete full-resolution (e.g., per display element 402) map of the color distribution across the spatial light modulator 130 may not be needed. Rather, one or more polynomials describing the curve shape of each color transition (e.g., red to green and green to red) may be sufficient, along with timing information that describes the rate of movement of the color transitions across the spatial light modulator 130. In some examples, the processor 920 may be programmed with the polynomial(s) and timing information, which can be used to control the bit plane generator 918 to produce appropriate bit planes

With a known spatial distribution of illumination across the spatial light modulator 130 as a function of time, multi-color bit plane sequences can be produced, with individual bit planes representing the color distribution at a particular moment in time. As described above, the frame memory stores (compressed or uncompressed) image frames/image data, and the frame memory controller 914 may extract the image data representing the red and green color components. For the light-recycling portion(s) of the frame period, the frame memory controller 914 may extract the red and green image data, which can be used by the bit plane generator 918 to produce the multi-color bit planes. For yellow (spoke) regions, the bit plane generator 918 may use a combination of the red and green image data to construct yellow bit planes that can be combined with red and green bit planes to generate the multi-color bit planes.

In some examples, multi-color bit plane sequences can be produced and output for the entire spatial light modulator 130, rather than for individual reset groups 404 as is the examples described above. Thus, in some examples, one or more global single-color (e.g., blue) bit plane sequences can be generated (and output) during the global illumination (e.g., blue) time slots of the frame period, and one or more global multi-color (e.g., red, green, and yellow) bit plane sequences can be generated (and output) during the light-recycling time slots of the frame period. In some examples, to account for movement of the spokes 510 across the spatial light modulator 130 during the light-recycling portions of the frame period, new multi-color bit planes (e.g., describing new spatial positions of the spokes 510 as they move) can be loaded to the spatial light modulator 130 at a rate that is selected based on the velocity of the spokes 510 across the spatial light modulator 130. In some examples, this load rate is relatively fast. For example, a new multi-color bit plane may be loaded every 25 to 40 microseconds.

According to certain examples, it may be preferable to have the velocity of the spokes 510 across the spatial light modulator 130 be approximately constant as this may simplify providing the PWM sequences for control of the spatial light modulator 130. Accordingly, the color filter wheel 232 may be configured to achieve approximately constant spoke velocity over the spatial light modulator. Two geometries of the color filter wheel 232 that can be achieve this condition are the Archimedean and involute of a circuit geometries described above. In addition, in some examples, the color filter wheel 232 can be configured to produce a constant color area ratio between the red light 244 and the green light 246 on the spatial light modulator 130. For example, the red/green color area ratio may be approximately 50/50 (e.g., roughly equal illumination with the red light 244 and the green light 246) to prevent brightness undulations and maximize the light recycling gain. In some examples, the curve parameter “a” can be tailored to achieve the desired color area ratio.

As described above, in some examples, it may be preferable to minimize the spoke size. As also described above, the bit depth defines the number of gray shades that can be produced for any color component of the image data. Large spokes 510 reduce the dwell time of red and green illumination on the spatial light modulator 130 and may “use up” bit depth otherwise available for red and green color components. Minimizing the spoke size/time reduces this problem. In some examples, it may be preferable to contain the curve height of a spoke 510 within one reset group 404 on the spatial light modulator 130. The curve parameter “a” and the diameter of the color filter wheel 232 may be modified to achieve this condition.

In some examples, the spatial light modulator 130 may include a relatively large array of display elements 402, for example, many thousands or tens of thousands of display elements 402. As described above, in some instances, the entire spatial light modulator 130 may need to be loaded with new multi-color bit planes quite quickly, such as every few tens of microseconds. This fast loading can be challenging for very large arrays. Accordingly, in some examples, control of the spatial light modulator 130 may be divided among multiple controllers 122, each responsible for a portion of the array of display elements 402.

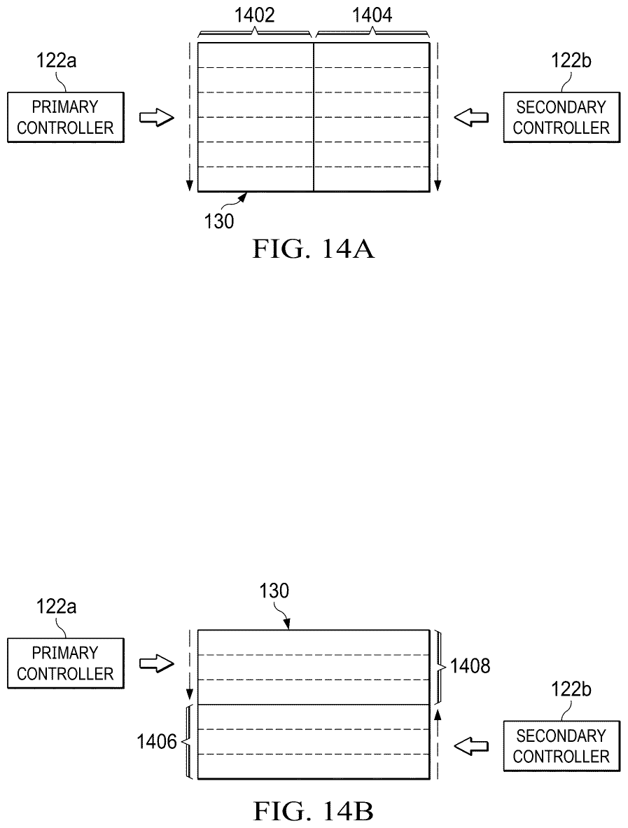

FIGS. 14A and 14B illustrate two examples of using two controllers 122a, 122b to control different regions of the spatial light modulator 130. For example, a primary controller 122a may control the left half 1402 of the spatial light modulator 130 while a secondary controller 122b controls the right half 1404, as shown in FIG. 14A (or vice versa). In another example, the primary controller 122a may control the top half 1406 of the spatial light modulator 130 while the secondary controller 122b controls the bottom half 1408, as shown in FIG. 14B (or vice versa). Numerous variations may be implemented. For example, the primary and secondary controllers 122a, 122b may control interleaved reset groups 404 or other groupings of reset groups 404. Further, in some examples, more than two controllers 122 may be used and the spatial light modulator array may therefore be partitioned into more than two regions. In some examples, the processor(s) 124 of FIG. 1 may control synchronization between the primary and secondary controllers 122a, 122b to ensure that appropriate bit plane sequences are loaded by each controller at the appropriate times. In other examples, the processor 920 of the primary controller 122a may control synchronization.

In some examples, the spoke size may be dependent on the number of reset groups 404 in the spatial light modulator 130. As described above, in some instances, it may be preferable to minimize the spoke size. Accordingly, in some examples, the controllers 122a, 122b may be configured to drive mutually exclusive sets of reset groups 404 within the spatial light modulator 130 (e.g., top and bottom, as in FIG. 11B, interleaved, or some other arrangement of sets of reset groups). With this arrangement, bit plane sequences can be loaded independently into different sets of reset groups by the different controllers 122a, 122b. Accordingly, bit planes for one set of reset groups may be loaded while a spoke traverses another set of reset groups, thereby minimizing the effective dwell time (and therefore size) of a spoke from the PWM sequence point of view of individual controllers 122a, 122b.

Thus, aspects and examples provide techniques for handling color transitions in the illumination light on a spatial light modulator in systems that employ light recycling. As described above, the phosphor wheel 204 and the color filter wheel 232 can be configured (e.g., in terms of color segment number, size, and arrangement) and operated (e.g., by controlling rate of rotation of both wheels) such that the illumination light 116 can be produced with specific patterns of color time slots. In some examples, the color segments (e.g., the pass-through region(s) and phosphor region(s) 210 on the phosphor wheel 204 and the segments 234 and 236 on the color filter wheel 232) can be sized and arranged to produce complementary pairs of color transitions in the illumination light 116 that can be combined (e.g., integrated) over time to produce a spatially uniform hue at the spatial light modulator 130. Color transitions (spokes) on the spatial light modulator 130 may be handling according to various bit plane generation techniques.

In some examples, during the light-recycling portions of illumination, temporally staggered (phased) copies of a bit plane sequence for a particular color component of an image frame can be output sequentially to different reset groups of the spatial light modulator at a rate that tracks movement of spokes across the spatial light modulator. This approach may avoid the need for paired bookend bits at the start and end of the light-recycling illumination time periods. As described above, the bit planes in the different copies of a particular bit plane sequence can be reordered as necessary to avoid load conflicts. The phased bit plane sequences for the light-recycling portions of the frame period can be used in combination with global bit plane sequences for global color illumination (e.g., during blue illumination time slots of the frame period).

In further examples, during the light-recycling portions of illumination, multi-color bit plane sequences can be generated based on a parametric description of the color filter wheel 232 that identifies the spatial location of spokes on the spatial light modulator at any given time. The color filter wheel 232 and the multi-color bit planes can be configured to minimize spoke dwell time on the spatial light modulator 130, as described above. Both approaches (multi-color bit planes and phased reset groups) can account for spoke curvature, avoiding the challenges associated with attempting to load data for curved transitions onto a rectangular array. Furthermore, in certain examples, multiple controllers 122 can be used to drive respective portions of the spatial light modulator, which may reduce effective spoke size and enable faster global load times (e.g., of the multi-color bit planes), as described above.

### Example Methodology

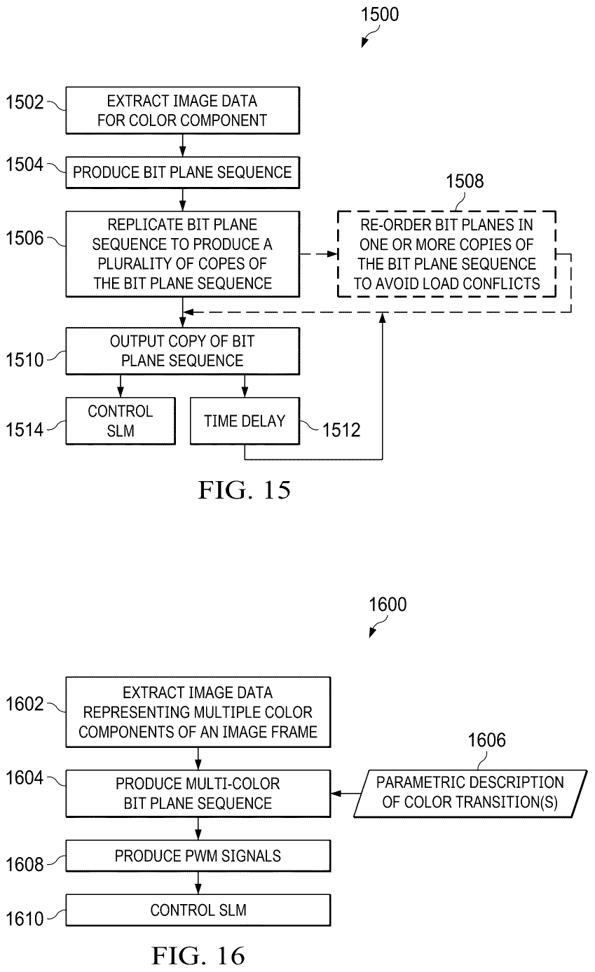

FIG. 15 is a flow diagram of a method 1500 of controlling a spatial light modulator according to certain examples. The method 1500, and variations thereof, may be performed by the controller 122, for example.

According to certain examples, at operation 1502, the control circuitry 908 (e.g., using the frame memory controller 914) may extract, from the frame memory 904, image data for a particular color component of an image to be displayed by the system 100.

At operation 1504, using the image data, the control circuitry 908 may generate a bit plane sequence. As described above, the bit plane sequence is a collection of bit planes, each bit plane representing a single bit of image data for every display element 402 one or more reset groups 404 of the spatial light modulator to be addressed with the bit plane sequence. In some examples, the bit plane sequence can generated by the bit plane generator 918, optionally in combination with (or under the control of) the processor 920.

At operation 1506, the bit plane generator 918 (optionally under control of the processor 920) may replicate the bit plane sequence to produce a plurality of copies of the bit plane sequence.

As described above, in some instances, depending on the arrangement of bit planes in the bit plane sequence and the timing between desired writes or loads of the copies of the bit plane sequence to various reset groups of the spatial light modulator, potential load conflicts may arise. Accordingly, if necessary, at operation 1508, the processor 920 may control the bit plane generator 918 to re-order the bit planes in one or more copies of the bit plane sequence to avoid load conflicts, as described above with reference to FIG. 11B.

At operation 1510, a copy of the bit plane sequence is output from the controller 122 (e.g., via the display formatter 910) to a first reset group of the spatial light modulator 130.

After a time delay at operation 1512, operation 1510 is repeated for the next copy of the bit plane sequence. As described above, the time delay between output of successive copies of the bit plane sequence may be based at least in part on the rate of rotation of the color filter wheel 232, and therefore the velocity of the spokes across the spatial light modulator 130. Operations 1510 and 1512 may be repeated as needed to load, over time, a respective copy of the bit plane sequence to each reset group 404 of the spatial light modulator 130 that is being controlled by the controller 122.

At operation 1514, the spatial light modulator 130 is controlled, by the controller 122, according to the bit plane sequence. For example, as described above, the bit plane sequence may describe the ON/OFF states, and durations thereof, of the individual display elements 402 of the spatial light modulator 130 for the particular color component(s). The display formatter 910 may convert the bit plane sequence into voltage signals that cause the display elements to transition between the ON state and the OFF state, thereby modulating the incident illumination light 116 to cause the system 100 to display one or more color components of the image frame at the display 140.

The method 1500 may be repeated for multiple color components of the image frame to allow the system 100 to display a full color image at the display 140.

Referring to FIG. 16, illustrated is a flow diagram of a method 1600 of controlling a spatial light modulator according to certain examples. The method 1600, and variations thereof, may be performed by the controller 122, for example. The method 1600 may be performed during a light-recycling portion of a frame period for display of an image frame, for example.

According to certain examples, at operation 1602, the frame memory controller 914 may extract image data representing multiple color components of an image frame to be displayed. For example, as described above, the multiple color components may include red and green components, from which a yellow color component can be derived.

At operation 1604, the bit plane generator 918 may generate a multi-color bit plane sequence using the image data.

In some examples, to produce the multi-color bit plane sequence, the processor 920 may control the bit plane generator 918 according to a parametric description of color transition(s) on the spatial light modulator 130. For example, as described above, parametric equations may describe, in terms of spatial coordinates (e.g., row and column number of display elements 402) and time, the shape and displacement (e.g., rate of movement) of the spokes 510 over the spatial light modulator 130. Using this parametric description, the processor 920 may determine, for a particular load time, the distribution of color of the illumination light 116 on the spatial light modulator 130. Accordingly, the processor 920 may control the bit plane generator 918 to generate a multi-color bit plane in which the image data for the proper color component(s) is used to match illumination of the display elements 402 with that color of light.

At operation 1608, PWM signals can be produced based on the multi-color bit plane sequence. For example, as described above, responsive to signals from the PWM sequencer 918, the bit planes of the multi-color bit plane sequence can be weighted (e.g., assigned to appropriate bit segments that control the duration of display of the respective bit planes).

At operation 1610, the spatial light modulator 130 can be controlled accordingly. For example, as described above, the display formatter 910 may generate corresponding control, e.g., voltage, signals 126 based on the weighted bit plane sequence to control the display elements 402 to transition between the ON state and the OFF state. Thus, the spatial light modulator 130 can be controlled by the controller 122 to project the image frame for display on the display 140.

### CONCLUSION

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A circuit or device that is described herein as including certain components may instead be adapted to be coupled to those components to form the described circuitry or device.

Elements that are “optically coupled” have an optical path between them. For example, element A and element B are optically coupled if light may travel from element A to element B and/or light may travel from element B to element A. Being optically coupled does not require light to be actively propagating between the elements. Optically coupled elements are in an arrangement where light, if present, is capable of propagating from element A to element B or from element B to element A. Additionally, elements that are optically coupled may have additional elements, for example lenses, mirrors, prisms, light tunnels, or other optical elements, in the light path between them.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/−10 percent of that parameter or +/−5 percent of that parameter.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples described herein can be practiced without certain, specific details. In other instances, well known methods, procedures, components, and circuitry have not been described in detail to avoid unnecessarily obscuring aspects of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### FURTHER EXAMPLES

The following examples pertain to further arrangements and/or implementations, from which numerous permutations and configurations will be apparent.

Example 1 is a method comprising: extracting from an image frame, with control circuitry, image data associated with a color component of the image frame; producing, with one or more processors of the control circuitry, a bit plane sequence responsive to the image data; and outputting, by the control circuitry, a plurality of copies of the bit plane sequence, respective copies of the bit plane sequence being output at respective time intervals with a time delay between successive time intervals.

Example 2 includes the method of Example 1, wherein the bit plane sequence comprises a plurality of bit planes, and wherein individual copies of the plurality of copies of the bit plane sequence comprise the plurality of bit planes arranged in different orders.

Example 3 includes the method of one of Examples 1 or 2, further comprising: extracting, with the control circuitry, one or more sets of image data from the image frame, individual sets of the image data being associated with respective additional color components of the image frame; producing, with the one or more processors, producing, with the one or more processors, an additional bit plane sequence responsive to the one or more sets of image data, respectively; and outputting, by the control circuitry, a plurality of copies of the additional bit plane sequence, output of respective copies of the additional bit plane sequence being delayed in time relative to one another.

Example 4 includes the method of Example 3, further comprising controlling, with the control circuitry, a spatial light modulator according to the bit plane sequence and the additional bit plane sequence to cause the spatial light modulator to display the image frame.

Example 5 includes the method one any one of Examples 1-3, further comprising: controlling, with the control circuitry, a spatial light modulator according to the plurality of copies of the bit plane sequence; wherein the spatial light modulator includes an array of display elements arranged into a plurality of reset groups; and wherein individual reset groups are controlled according to corresponding individual copies of the plurality of copies of the bit plane sequence.

Example 6 includes the method of Example 5, further comprising: while controlling the spatial light modulator, illuminating the spatial light modulator with light having a color corresponding to the color component of the image frame.

Example 7 includes the method of Example 6, further comprising determining, by the one or more processors, the time delay responsive to a rate of travel of the light across the spatial light modulator from one reset group to a next reset group; wherein outputting the plurality of copies of the bit plane sequence comprises staggering output of the plurality copies of the bit plane sequence in time with the time delay between a start of the output of individual copies of the bit plane sequence.

Example 8 include the method of any one of Examples 1-7, further comprising storing the image frame in a frame memory coupled to the one or more processors, wherein producing the bit plane sequence includes accessing, with the one or more processors, the image frame stored in the frame memory.

Example 9 is a system configurable to implement the method of any one of Examples 1-8.

Example 10 is a system comprising: a spatial light modulator; an illumination system optically coupled to the spatial light modulator, the illumination system comprising a color wheel; and a display controller coupled to the spatial light modulator. The display controller includes a frame memory configurable to store an image frame, a frame memory controller coupled to the frame memory, the frame memory controller configurable to obtain image data from the image frame, the image data associated with a color component of the image frame, and a bit plane generator coupled to the frame memory controller, the bit plane generator configurable to produce a bit plane sequence responsive to the image data. The display controller is configurable to output first and second copies of the bit plane sequence to the spatial light modulator at first and second time intervals, respectively, a time delay between the first and second time intervals being synchronized with a rate of rotation of the color wheel.

Example 11 includes the system of Example 10, wherein the spatial light modulator comprises an array of display elements arranged into at least first and second reset groups, and wherein the display controller is configurable to output the first copy of the bit plane sequence to the first reset group at the first time interval, and to output the second copy of the bit plane sequence to the second reset group at the second time interval.

Example 12 includes the system of Example 11, wherein: the bit plane sequence comprises a plurality of bit planes; the first copy of the bit plane sequence includes the plurality of bit planes arranged in a first order; and the second copy of the bit plane sequence includes the plurality of bit planes arranged in a second order different from the first order.

Example 13 includes the system of one of Examples 11 or 12, wherein: the illumination system comprises a light source optically coupled to the color wheel and configurable to emit illumination light; the color wheel includes a color filter wheel configurable to filter the illumination light to produce filtered light, the illumination system configurable to illuminate the spatial light modulator with the filtered light; and the display controller is configurable to output the first and second copies of the bit plane sequence to the spatial light modulator while the spatial light modulator is illuminated with the filtered light having a color corresponding to the color component of the image frame.

Example 14 includes the system of Example 13, wherein the color filter wheel comprises a first segment to transmit first light having a first color and to reflect second light having a second color, and a second segment to transmit the second light having the second color and to reflect the first light having the first color.

Example 15 includes the system of Example 14, wherein the first and second segments are arranged in interleaved spirals on the color filter wheel.

Example 16 includes the system of one of Examples 14 or 15, wherein the illumination system comprises a phosphor wheel optically coupled between the light source and the color filter wheel, the phosphor wheel having a third segment to transmit third light having a third color, and a fourth segment to emit fourth light having a fourth color, wherein the third color comprises a combination of the first and second colors, and wherein the first and second segments of the color filter wheel are configured to transmit the fourth light having the fourth color.

Example 17 includes the system of Example 16, wherein the phosphor wheel and the color filter wheel are configured and aligned in phase and frequency of rotation to produce the filtered light with a pattern of time slots, and wherein the pattern of time slots comprises a first time slot of the filtered light having the fourth color, followed by a first alternating sequence of time slots of the filtered light having the first color and then the second color, followed by a second time slot of the filtered light having the fourth color, and followed a second alternating sequence of time slots of the filtered light having the second color and then the first color.

Example 18 includes the system of one of Examples 16 or 17, wherein the illumination system further comprises an integrator rod optically coupled between the phosphor wheel and the color filter wheel, the integrator rod having a reflective internal surface and an aperture on an end of the integrator rod facing the phosphor wheel.

Example 19 includes the system of Example 18, wherein the aperture is round.

Example 20 includes the system of any one of Examples 16-19, wherein the phosphor wheel has a first side and a second side; wherein the illumination system further comprises a dichroic mirror having a first side and a second side, the second side of the dichroic mirror optically coupled to the integrator rod and the first side of the dichroic mirror optically coupled to the first side of the phosphor wheel; and a series of mirrors optically coupling the second side of the phosphor wheel to the second side of the dichroic mirror; and wherein the light source is optically coupled to the first side of the dichroic mirror.

Example 21 is a system comprising: a light source configurable to emit first light having a first color; a phosphor wheel optically coupled to the light source, the phosphor wheel comprising a first segment to transmit the first light and a second segment to emit, responsive to the first light, second light having a second color; a color filter wheel optically coupled to the phosphor wheel, the color filter wheel comprising a third segment to transmit the first light and a first component of the second light and to reflect a second component of the second light, and a fourth segment to transmit the first light and the second component of the second light and to reflect the first component of the second light, wherein the first component of the second light has a third color and the second component of the second light has a fourth color; and a controller configurable to synchronize rotation of the phosphor wheel with rotation of the color filter wheel to cause the color filter wheel to transmit filtered light in a pattern of color time slots, wherein the pattern of color time slots comprises a first time slot of the first color, followed by a first series of alternating time slots of the third color and the fourth color, followed by a second time slot of the first color, followed by a second series of alternative time slots of the fourth color and the third color.

Example 22 includes the system of Example 21, further comprising a spatial light modulator optically coupled to the color filter wheel and configurable to display an image responsive to the filtered light.

Example 23 includes the system of Example 22, wherein the controller is further configurable to output to the spatial light modulator, for each color time slot, a plurality of copies of a respective bit plane sequence to control the spatial light modulator to display the image, the respective bit plane sequence being derived from image data associated with a corresponding color component of the image, and output of individual copies of the respective bit plane sequence being staggered in time over a duration of the color time slot.

Example 24 is a computer program product comprising one or more non-transitory machine-readable media having instructions encoded thereon that when executed by at least one processor cause a method to be carried out, the method comprising: extracting, from an image frame, image data associated with a color component of the image frame; producing a bit plane sequence responsive to the image data; and outputting a plurality of copies of the bit plane sequence, respective copies of the bit plane sequence being output at respective time intervals with a time delay between successive time intervals.

Example 25 is a controller comprising: a frame memory to store an image frame; a frame memory controller coupled to the frame memory, the frame memory controller configurable to obtain image data from the image frame, the image data associated with a color component of the image frame; a bit plane generator coupled to the frame memory controller, the bit plane generator configurable to produce a bit plane sequence responsive to the image data; and a processor coupled to the bit plane generator and configurable to instruct the controller to output a plurality of copies of the bit plane sequence staggered in time.

Example 26 is a system comprising: a spatial light modulator; an illumination system optically coupled to the spatial light modulator, the illumination system comprising a color wheel; and a display controller coupled to the spatial light modulator. The display controller includes a frame memory to store an image frame, a frame memory controller coupled to the frame memory, the frame memory controller configurable to obtain image data from the image frame, the image data associated with a color component of the image frame, and a bit plane generator coupled to the frame memory controller, the bit plane generator configurable to produce a bit plane sequence responsive to the image data; wherein the display controller is configurable to output a plurality of copies of the bit plane sequence to the spatial light modulator at a series of time intervals, a time delay between respective time intervals in the series of time intervals being synchronized with a rate of rotation of the color wheel.

Example 27 includes the system of Example 26, wherein the spatial light modulator comprises an array of display elements arranged into a plurality of reset groups, and wherein the display controller is configurable to output respective copies of the bit plane sequence to sequential reset groups of the plurality of reset groups at the series of time intervals.

Example 28 includes the system of Example 27, wherein the bit plane sequence comprises a plurality of bit planes; wherein one or more copies of the plurality of copies of the bit plane sequence includes the plurality of bit planes arranged in a first order; and wherein at least one other copy of the plurality of copies of the bit plane sequence includes the plurality of bit planes arranged in a second order different from the first order.

Example 29 includes the system of one of Examples 27 or 28, wherein: the illumination system comprises a light source optically coupled to the color wheel and configurable to emit illumination light; the color wheel includes a color filter wheel to filter the illumination light to produce filtered light, the illumination system configurable to illuminate the spatial light modulator with the filtered light; and the display controller is configurable to output the plurality of copies of the bit plane sequence to the spatial light modulator while the spatial light modulator is illuminated with the filtered light having a color corresponding to the color component of the image frame.

Example 30 includes the system of Example 29, wherein the color filter wheel comprises: a first segment to transmit first light having a first color and to reflect second light having a second color; and a second segment to transmit the second light having the second color and to reflect the first light having the first color.

Example 31 includes the system of Example 30, wherein the first and second segments are arranged in interleaved spirals on the color filter wheel.

Example 32 includes the system of one of Examples 30 or 31, wherein the illumination system comprises a phosphor wheel optically coupled between the light source and the color filter wheel, the phosphor wheel having a third segment to transmit third light having a third color, and a fourth segment to emit fourth light having a fourth color, wherein the third color comprises a combination of the first and second colors, and wherein the first and second segments of the color filter wheel transmit the fourth light having the fourth color.

Example 33 includes the system of Example 32, wherein the phosphor wheel and the color filter wheel are configured and aligned in phase and frequency of rotation to produce the filtered light with a pattern of time slots, and wherein the pattern of time slots comprises a first time slot of the filtered light having the fourth color, followed by a first alternating sequence of time slots of the filtered light having the first color and then the second color, followed by a second time slot of the filtered light having the fourth color, and followed a second alternating sequence of time slots of the filtered light having the second color and then the first color.

Example 34 includes the system of one of Examples 32 or 33, wherein the illumination system further comprises an integrator rod optically coupled between the phosphor wheel and the color filter wheel, the integrator rod having a reflective internal surface and an aperture on an end of the integrator rod facing the phosphor wheel.

Example 35 includes the system of Example 34, wherein the aperture is round.

Example 36 is a system comprising: a spatial light modulator; an illumination system optically coupled to the spatial light modulator, the illumination system comprising a color wheel comprising a plurality of segments to transmit light of different colors; and a display controller coupled to the spatial light modulator. The display controller includes a frame memory to store an image frame, and control circuitry coupled to the frame memory and configurable to obtain image data representing a plurality of color components of the image frame, the control circuitry configurable to produce a multi-color bit plane sequence responsive to the image data and to a parametric description of an illumination pattern on the spatial light modulator of the light transmitted from the color wheel, the control circuitry further configurable to output the multi-color bit plane sequence to the spatial light modulator to control the spatial light modulator to display the image frame.

Example 37 includes the system of Example 36, wherein the spatial light modulator comprises an array of display elements, and wherein the control circuitry is configurable to output the multi-color bit plane sequence to the array of display elements substantially simultaneously.

Example 38 includes the system of one of Examples 36 or 37, wherein the parametric description of the illumination pattern comprises a parametric description in time and space of a location of at least one spoke on the spatial light modulator, the at least one spoke being a transition between first and second colors of the light.

Example 39 includes the system of Example 38, wherein a shape of the at least one spoke in space is parabolic.

Example 40 includes the system of any one of Examples 36-39, wherein the plurality of segments of the color wheel comprises: a first segment to transmit first light of a first color and to reflect second light of a second color; and a second segment to transmit the second light of the second color and to reflect the first light of the first color.

Example 41 includes the system of Example 40, wherein the illumination system further comprises a light source and an integrator rod optically coupled between the light source and the color wheel.

Example 42 includes the system of Example 41, wherein the light source comprises: a laser to emit third light of a third color; and a phosphor wheel optically coupled between the laser and the integrator rod, the phosphor wheel including a third segment to transmit the third light of the third color and a fourth segment to emit, responsive to the third light, fourth light of a fourth color, wherein the fourth color is a combination of the first and second colors.

Example 43 includes the system of Example 42, wherein the integrator rod has a reflective internal surface and an aperture on an end of the integrator rod facing the phosphor wheel.

Example 44 includes the system of Example 43, wherein the aperture is round.

Example 45 includes the system of any one of Examples 42-44, wherein the first and second segments of the color wheel transmit the third light of the third color.

Example 46 includes the system of Example 45, wherein the parametric description of the illumination pattern comprises: a first parametric description in time and space of a location of a first spoke on the spatial light modulator, the first spoke being a transition between the first and second colors; and a second parametric description in time and space of a location of a second spoke on the spatial light modulator, the second spoke being a transition between the third color and one of the first or second colors.

Example 47 includes the system of any one of Examples 36-46, wherein the control circuitry comprises: a frame memory controller coupled to the frame memory and configurable to obtain the image data from the image frame; and a bit plane generator coupled to the frame memory controller, the bit plane generator configurable to produce the multi-color bit plane sequence responsive to the image data.

Example 48 is a system comprising: a spatial light modulator; and a display controller coupled to the spatial light modulator and configurable to control the spatial light modulator according to a multi-color bit plane sequence, the display controller including a frame memory to store an image frame, a frame memory controller configurable to obtain image data from the image frame, the image data representing a plurality of color components of the image frame, a bit plane generator coupled to the frame memory controller, the bit plane generator configurable to produce the multi-color bit plane sequence responsive to the image data, and a processor coupled to the bit plane generator, the processor configurable to control the bit plane generator to produce the multi-color bit plane sequence according to a parametric description of one or more color transitions of multi-color illumination on the spatial light modulator.

Example 49 includes the system of Example 48, further comprising an illumination system optically coupled to the spatial light modulator and configurable to produce the multi-color illumination.

Example 50 includes the system of Example 49, wherein the illumination system comprises a color wheel including a first segment to transmit first light of a first color and to reflect second light of a second color, and a second segment to transmit the second light of the second color and to reflect the first light of the first color.

Example 51 includes the system of Example 50, wherein the illumination system further comprises: a light source to emit third light of a third color; and a phosphor wheel optically coupled between the light source and the color wheel, the phosphor wheel including a third segment to transmit the third light of the third color and a fourth segment to emit, responsive to the third light, fourth light of a fourth color, wherein the fourth color is a combination of the first and second colors.

Example 52 includes the system of Example 51, wherein the phosphor wheel and the color wheel are aligned in phase and frequency of rotation to produce the multi-color illumination comprising a sequence of color time slots including a first time slot of the third color, followed by a first series of alternating time slots of the first and second colors, followed by a second time slot of the third color, followed by a second series of alternating time slots of the second and first colors.

Example 53 includes the system of any one of Examples 48-52, wherein a shape of at least one of the one or more color transitions is parabolic.

Example 54 includes the system of any one of Examples 48-53, wherein the parametric description of the one or more color transitions comprises, for each of the one or more color transitions, a parametric description in time and space of a respective location of the color transition on the spatial light modulator.

Example 55 includes the system of any one of Examples 48-54, wherein the display controller further comprises a pulse width modulation (PWM) sequencer coupled to the bit plane generator and to the processor, the PWM sequencer configurable to modulate the multi-color bit plane sequence to produce a sequence of PWM control signals for controlling the spatial light modulator.

Example 56 is a method comprising: extracting from an image frame, with control circuitry, image data representing a plurality of color components of the image frame; accessing, with a processor of the control circuitry, a stored parametric description of one or more color transitions of multi-color illumination on a spatial light modulator; producing, with the processor, a multi-color bit plane sequence responsive to the image data and the parametric description; and generating, from the multi-color bit plane sequence, a sequence of pulse width modulation (PWM) control signals to control the spatial light modulator to display the image frame responsive to the multi-color illumination.

Example 57 includes the method of Example 56, further comprising: illuminating the spatial light modulator with the multi-color illumination; wherein the multi-color illumination includes a pattern of color time slots, the pattern including a first time slot of a first color, followed by a first series of alternating time slots of a second color and a third color, followed by a second time slot of the first color, followed by a second series of alternating time slots of the third color and the second color; and wherein the parametric description describes locations, on the spatial light modulator, in space and time of color transitions between (i) the first color and the second color, (ii) the second color and the third color, and (iii) the first color and the third color.

Example 58 is a system configurable to implement the method of one of Examples 56 or 57.

1. A method comprising:
extracting from an image frame, with control circuitry, image data associated with a color component of the image frame;
producing, with one or more processors of the control circuitry, a bit plane sequence responsive to the image data; and
outputting, by the control circuitry, a plurality of copies of the bit plane sequence, respective copies of the bit plane sequence being output at respective time intervals with a time delay between successive time intervals.

2. The method of claim 1, wherein the bit plane sequence comprises a plurality of bit planes, and wherein individual copies of the plurality of copies of the bit plane sequence comprise the plurality of bit planes arranged in different orders.

3. The method of claim 1, further comprising:
extracting, with the control circuitry, one or more sets of image data from the image frame, individual sets of the image data being associated with respective additional color components of the image frame;
producing, with the one or more processors, an additional bit plane sequence responsive to the one or more sets of image data, respectively; and
outputting, by the control circuitry, a plurality of copies of the additional bit plane sequence, output of respective copies of the additional bit plane sequence being delayed in time relative to one another.

4. The method of claim 3, further comprising:
controlling, with the control circuitry, a spatial light modulator according to the bit plane sequence and the additional bit plane sequence to cause the spatial light modulator to display the image frame.

5. The method of claim 1, further comprising:
controlling, with the control circuitry, a spatial light modulator according to the plurality of copies of the bit plane sequence;
wherein the spatial light modulator includes an array of display elements arranged into a plurality of reset groups; and
wherein individual reset groups are controlled according to corresponding individual copies of the plurality of copies of the bit plane sequence.

6. The method of claim 5, further comprising:
while controlling the spatial light modulator, illuminating the spatial light modulator with light having a color corresponding to the color component of the image frame.

7. The method of claim 6, further comprising:
determining, by the one or more processors, the time delay responsive to a rate of travel of the light across the spatial light modulator from one reset group to a next reset group;
wherein outputting the plurality of copies of the bit plane sequence comprises staggering output of the plurality copies of the bit plane sequence in time with the time delay between a start of the output of individual copies of the bit plane sequence.

8. The method of claim 1, further comprising storing the image frame in a frame memory coupled to the one or more processors; and
wherein producing the bit plane sequence includes accessing, with the one or more processors, the image frame stored in the frame memory.

9. A system comprising:
a spatial light modulator;
an illumination system optically coupled to the spatial light modulator, the illumination system comprising a color wheel; and
a display controller coupled to the spatial light modulator, the display controller including
a frame memory configurable to store an image frame,
a frame memory controller coupled to the frame memory, the frame memory controller configurable to obtain image data from the image frame, the image data associated with a color component of the image frame, and
a bit plane generator coupled to the frame memory controller, the bit plane generator configurable to produce a bit plane sequence responsive to the image data;
wherein the display controller is configurable to output first and second copies of the bit plane sequence to the spatial light modulator at first and second time intervals, respectively, a time delay between the first and second time intervals being synchronized with a rate of rotation of the color wheel.

10. The system of claim 9, wherein the spatial light modulator comprises an array of display elements arranged into at least first and second reset groups, and wherein the display controller is configurable to output the first copy of the bit plane sequence to the first reset group at the first time interval, and to output the second copy of the bit plane sequence to the second reset group at the second time interval.

11. The system of claim 10, wherein:
the bit plane sequence comprises a plurality of bit planes;
the first copy of the bit plane sequence includes the plurality of bit planes arranged in a first order; and
the second copy of the bit plane sequence includes the plurality of bit planes arranged in a second order different from the first order.

12. The system of claim 10, wherein:
the illumination system comprises a light source optically coupled to the color wheel and configurable to emit illumination light;
the color wheel includes a color filter wheel configurable to filter the illumination light to produce filtered light, the illumination system configurable to illuminate the spatial light modulator with the filtered light; and
the display controller is configurable to output the first and second copies of the bit plane sequence to the spatial light modulator while the spatial light modulator is illuminated with the filtered light having a color corresponding to the color component of the image frame.

13. The system of claim 12, wherein the color filter wheel comprises:
a first segment to transmit first light having a first color and to reflect second light having a second color; and
a second segment to transmit the second light having the second color and to reflect the first light having the first color.

14. The system of claim 13, wherein the first and second segments are arranged in interleaved spirals on the color filter wheel.

15. The system of claim 13, wherein the illumination system comprises a phosphor wheel optically coupled between the light source and the color filter wheel, the phosphor wheel having a third segment to transmit third light having a third color, and a fourth segment to emit fourth light having a fourth color, wherein the third color comprises a combination of the first and second colors, and wherein the first and second segments of the color filter wheel are configured to transmit the fourth light having the fourth color.

16. The system of claim 15, wherein the phosphor wheel and the color filter wheel are configured and aligned in phase and frequency of rotation to produce the filtered light with a pattern of time slots, and wherein the pattern of time slots comprises a first time slot of the filtered light having the fourth color, followed by a first alternating sequence of time slots of the filtered light having the first color and then the second color, followed by a second time slot of the filtered light having the fourth color, and followed a second alternating sequence of time slots of the filtered light having the second color and then the first color.

17. The system of claim 15, wherein the illumination system further comprises an integrator rod optically coupled between the phosphor wheel and the color filter wheel, the integrator rod having a reflective internal surface and an aperture on an end of the integrator rod facing the phosphor wheel.

18. A system comprising:
a light source configurable to emit first light having a first color;
a phosphor wheel optically coupled to the light source, the phosphor wheel comprising a first segment to transmit the first light and a second segment to emit, responsive to the first light, second light having a second color;
a color filter wheel optically coupled to the phosphor wheel, the color filter wheel comprising a third segment to transmit the first light and a first component of the second light and to reflect a second component of the second light, and a fourth segment to transmit the first light and the second component of the second light and to reflect the first component of the second light, wherein the first component of the second light has a third color and the second component of the second light has a fourth color; and
a controller configurable to synchronize rotation of the phosphor wheel with rotation of the color filter wheel to cause the color filter wheel to transmit filtered light in a pattern of color time slots, wherein the pattern of color time slots comprises a first time slot of the first color, followed by a first series of alternating time slots of the third color and the fourth color, followed by a second time slot of the first color, followed by a second series of alternating time slots of the fourth color and the third color.

19. The system of claim 18, further comprising:
a spatial light modulator optically coupled to the color filter wheel and configurable to display an image responsive to the filtered light.

20. The system of claim 19, wherein the controller is further configurable to output to the spatial light modulator, for each color time slot, a plurality of copies of a respective bit plane sequence to control the spatial light modulator to display the image, the respective bit plane sequence being derived from image data associated with a corresponding color component of the image, and output of individual copies of the respective bit plane sequence being staggered in time over a duration of the color time slot.
